(19) United States
(12) Patent Application Publication
(10) Pub. No.: US 2013/0317808 A1
(43) Pub. Date: Nov. 28, 2013

(54) SYSTEM FOR AND METHOD OF ANALYZING AND RESPONDING TO USER GENERATED CONTENT

(71) Applicants: Chachi Kruel, Salt Lake City, UT (US); Ron McCoy, New York, NY (US); Howard Sherman, New York, NY (US); Alexander Daw, American Fork, UT (US)

(72) Inventors: Chachi Kruel, Salt Lake City, UT (US); Ron McCoy, New York, NY (US); Howard Sherman, New York, NY (US); Alexander Daw, American Fork, UT (US)

(73) Assignee: About, Inc., New York, NY (US)

(21) Appl. No.: 13/618,072

(22) Filed: Sep. 14, 2012

Related U.S. Application Data
(60) Provisional application No. 61/651,216, filed on May 24, 2012.

(51) Int. Cl. G06F 17/27

(52) U.S. Cl. 704/9

(57) ABSTRACT

A computer implemented system and method for automatically generating a response to a user generated content, the system comprises an interface configured to receive, via a communication network, user generated content from at least one social networking source; a natural language processor configured to process one or more terms from the user generated content to identify the user generated content; a programmed computer processor configured to match the identified user generated content with at least one resource provided by a content provider; an electronic storage component configured to store a reference to the at least one resource; a programmed computer processor configured to generate a response to the user generated content, wherein the resource comprises the reference to the at least one resource; and a programmed computer processor configured to provide, via a communication network, the response to the social networking source.

### CROSS REFERENCE TO RELATED APPLICATIONS

This application claims priority to Provisional Application No. 61/651,216 filed on May 24, 2012. The contents of this priority application are incorporated herein by reference in its entirety.

### FIELD OF THE INVENTION

The present invention relates to providing content, generally, and more specifically to a system for and method of finding, analyzing and responding to user generated content.

### BACKGROUND INFORMATION

Social networking tools have become widely popular among Internet users in recent years. Many content providers and marketers consider social networks to be significant distribution resources for sharing electronic content. Accordingly, these content providers and marketers may desire to learn new and better ways to leverage the distribution of electronic content through social networking tools or through social networks.

Traditionally, content has been distributed by building a brand that attracts direct traffic or visitors from search engines through search engine optimization to index content that can be prominently displayed in search engine results. This model makes finding information for the consumer as easy as submitting a keyword phrase and reviewing a list of web sites. The challenge for today's media companies and/or content delivery sources lies in providing content that answers users' questions and responds to other needs expressed across the burgeoning social graph.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 illustrates a block diagram of an exemplary system for analyzing and responding to user generated content, according to an embodiment of the present invention;

FIG. 2 is a flow chart illustrating a method of analyzing and responding to user generated content according to an embodiment of the invention;

FIG. 3 is a flow chart illustrating a method of classifying user generated content according to an embodiment of the invention;

FIG. 4 illustrates a block diagram of an exemplary system architecture, according to an embodiment of the present invention;

FIG. 5 is an exemplary flowchart for generating and enhancing responses, according to an embodiment of the present invention;

FIG. 6 illustrates a language processing services architecture for generating responses, according to an embodiment of the present invention;

FIG. 7 illustrates an exemplary language processing services API, according to an embodiment of the present invention;

FIG. 8 is an exemplary screenshot illustrating monitored keywords, according to an embodiment of the present invention;

FIG. 9 is an exemplary screen shot illustrating recent collected and matched events, according to an embodiment of the present invention;

FIG. 10 is an exemplary screen shot illustrating recent classifications, according to an embodiment of the present invention;

FIG. 11 is an exemplary screen shot illustrating a questions view, according to an embodiment of the present invention;

FIG. 12 is an exemplary screen shot illustrating top response landing URLs, according to an embodiment of the present invention;

FIG. 13 is an exemplary screen shot illustrating response URL details, according to an embodiment of the present invention;

FIG. 14 is an exemplary screen shot illustrating keyword frequencies, according to an embodiment of the present invention;

FIG. 15 is an exemplary screen shot illustrating a real-time activities panel, according to an embodiment of the present invention;

FIG. 16 is an exemplary screen shot illustrating a live questions graphic, according to an embodiment of the present invention;

FIG. 17 is an exemplary screen shot illustrating a live events graphic, according to an embodiment of the present invention;

FIG. 18 an exemplary screen shot illustrating a live clicks graphic, according to an embodiment of the present invention;

FIG. 19 an exemplary screen shot illustrating a responses graphic, according to an embodiment of the present invention;

FIG. 20 an exemplary screen shot illustrating a flags graphic, according to an embodiment of the present invention;

FIG. 21 an exemplary screen shot illustrating a rejections graphic, according to an embodiment of the present invention;

FIG. 22 is an exemplary screen shot illustrating a custom response graphic, according to an embodiment of the present invention;

FIG. 23 an exemplary screen shot illustrating an automatic response interface, according to an embodiment of the present invention; and

FIG. 24 an exemplary screen shot illustrating an overlay at a publisher's website, according to an embodiment of the present invention.

### SUMMARY OF EMBODIMENTS OF THE INVENTION

At least one exemplary embodiment is directed to a system for and a method of finding, analyzing and responding to user generated content created on social networks, websites and mobile applications. A computer implemented method and system for automatically generating a response to a user generated content comprises receiving, via a communication network, user generated content from at least one social networking source; processing, via at least one computer processor, the user generated content; matching, via at least one computer processor, the user generated content with at least one resource provided by a content provider; generating, via at least one computer processor, a response to the user generated content, wherein the resource comprises a reference to the at least one resource; providing, via a communication network, the response to the social networking source.

### DETAILED DESCRIPTION OF EMBODIMENTS OF THE INVENTION

Consumers use online sources to find information, especially about products and services they are considering purchasing. Many times a good amount of time and analysis are involved when researching potential products and services. Social networks provide a way for users to create and share content with each other and beyond. While search engines provide a meaningful way to search for information, recommendations from individuals within a consumer's social network hold sway for many. These recommendations are more plentiful and prominent than ever with the help of user generated content tools like microblogs, social networking tools, question and answer networks, image aggregators—to characterize just a few. Moreover, the growth of mobile devices has accelerated such social interaction.

With social media, publishers are able to respond directly to users and not only answer a question but engage in a conversation—something more collaborative than searching for information through a website. Any company can establish a presence on various social networking websites to answer product research questions of their followers or any other member of those ecosystems. However, this can be a time consuming and difficult process to scale as the queries would have to be manually scanned, responded to, and further monitored.

An embodiment of the present invention is directed to an automated system for and method of finding, analyzing and responding to user generated content created on social networks, on web sites and in mobile applications. User generated content may include questions, comments, statements, status updates and/or other information posted by a user on a networking site and/or other user generated content tool. The system may employ natural language processing (NLP) and/or other processing tools to determine if users are asking questions that a publisher's content can address and/or directly answer. Responses may be sent automatically and/or manually with editorial control. Click tracking and/or other tracking tool provides statistics on user engagement, and response monitoring may record the user's sentiment on the response.

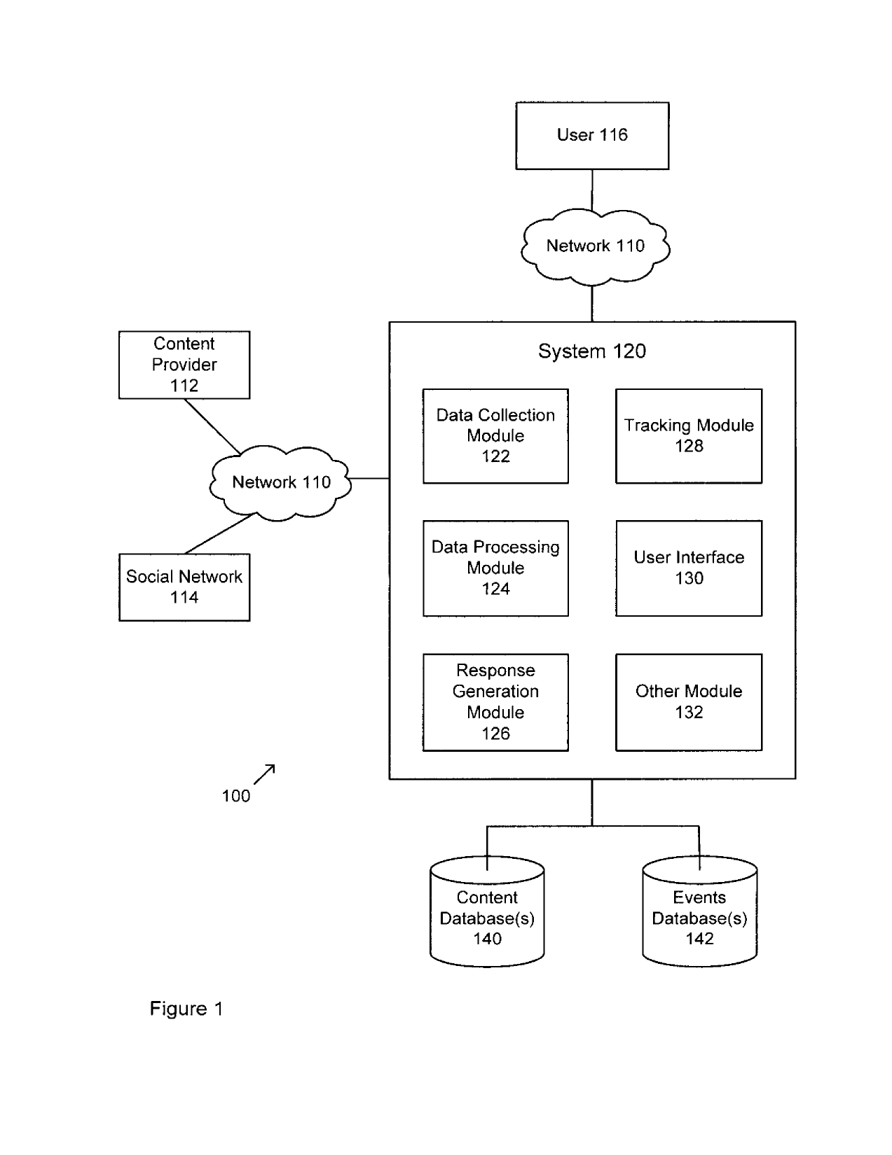

FIG. 1 illustrates a block diagram of an exemplary system for analyzing and responding to user generated content, according to an embodiment of the present invention.

In one embodiment, various users, such as content provider 112 and user 116, may communicate with a system 120 via a network communication 110. System 120 may include modules and processors to perform various functionality, such as collecting data, processing data and/or generating responses. The system 120 may be communicatively coupled to social networking sites 114 and other sources of data using any, or a combination, of data networks and various data paths, as represented by Network 110. Social Network 114 may be representative of various networking sites, such as microblogs, social networking tools, question and answer networks, image and aggregators, etc. Accordingly, data signals may be transmitted to any of the components illustrated in 100 and transmitted from any of the components using any, or a combination, of data networks and various data paths.

The data networks, represented by 110, may be a wireless network, a wired network, or any combination of wireless network and wired network. For example, the data network may include any, or a combination, of a fiber optics network, a passive optical network, a radio near field communication network (e.g., a Bluetooth network), a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.l, 802.11n and 802.11g or any other wired or wireless network configured to transmit or receive a data signal. In addition, the data network may include, without limitation, a telephone line, fiber optics, IEEE Ethernet 802.3, a wide area network (WAN), a LAN, or a global network, such as the Internet. Also, the data network may support, an Internet network, a wireless communication network, a cellular network, a broadcast network, or the like, or any combination thereof. The data network may further include one, or any number of the exemplary types of networks mentioned above operating as a stand-alone network or in cooperation with each other. The data network may utilize one or more protocols of one or more network elements to which it is communicatively coupled. The data network may translate to or from other protocols to one or more protocols of network devices. It should be appreciated that according to one or more embodiments, the data network may comprise a plurality of interconnected networks, such as, for example, a service provider network, the Internet, a broadcaster's network, a cable television network, corporate networks, and home networks.

Each illustrative block may transmit data to and receive data from data networks. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. The data network 104 may use standard wireless protocols including IEEE 802.11a, 802.11b, 802.11g, and 802.11n. The data network may also use protocols for a wired connection, such as an IEEE Ethernet 802.3.

The data paths disclosed herein may include any device that communicatively couples devices to each other. For example, a data path may include one or more networks or one or more conductive wires (e.g., copper wires).

System 120 may include, but is not limited to, a computer device or communications device. For example, system 120 may include a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to receive user generated content and store various resources (e.g., electronic content, digitally published newspaper articles, digitally published magazine articles, electronic books) and generate responses to user generated content. System 120 may be associated with one or more content providers or operated by an independent entity, such as a clearinghouse or other service provider.

System 120 may include computer-implemented software, hardware, or a combination of both, configured to maintain content from content providers, analyze user generated content from social networking websites and other sources and identify appropriate responses to the user generated content.

In one embodiment, one or more content providers, as illustrated by 112, may provide content to system 120. A content provider 112, such as a publisher, news source, online magazine, may set up lists of the articles, pages, or other content items they wish to make available. Content providers may also include news publishers, advertisers, merchants, retailers, financial institutions, and/or any entity that provides content, information, data, images, audio, video, etc. Content may be provided by a single source or multiple sources. Aggregated content from multiple content providers may be available to subscribers, advertisers, marketers and/or other interested entities. The aggregated content may be accessible via a network connection. For multiple sources, system 120 may be operated by a clearinghouse entity that receives and stores content from a plurality of content providers and provides searching capabilities for the aggregated content for a plurality of subscribers, advertisers and/or marketers.

To further increase the universal applications of the various features of the present invention, additional data acquisition channels may be added to the system. These may include data collected through focused domain specific web crawls, periodicals, digital magazines, stock market trends, retailer inventory indexes, product price indexes as well as other sources of data.

User generated content may include content from a social networking site, as represented by 114, and/or other sources of user content. User generated content may include posts, comments, blogs, microblogs, messages, images, audio, video, requests, etc. For example, a social network user may post a comment, expressing a need or a want: “I need a new TV!” or “My digital camera is broken again . . . need one that is more reliable!” Another example may include a question, such as “Can anyone recommend quick and easy recipes for dinner?” A user may also post a message concerning a like or a dislike, such as “I love my best friend's new car!” or “I love my new hair color.” User generated content may also include user actions, such as accepting an invitation, joining a group, “liking” content that another user posted, shared and/or generated and/or other action.

An embodiment of the present invention may generate an appropriate response for user generated content. The response may include an answer, a comment, a link, a reference to a link as well as data, image, animation, video and/or other type of information from one or more content providers 112 and/or other source of data. The response may include any, or a combination, of electronic content, advertisements, reports, digitally published newspaper articles, digitally published magazine articles, and electronic books. The response may also include a personalized message for the specific user or may be catered to a type of user generated content. For example, a response may include “Here's a list of the top rated flat screen TVs . . . ” or “The top rated vegetarian dishes are here . . . ” or “Here's a link to 5 easy recipes.” In response to the broken camera post, a response may include “Check out the new Brand A camera,” or “Your friends really like Brand Y cameras.” If the user is connected to a highly influential user, the respond may include “Did you know that Joey X bought the Brand Z camera.” With the response, a link to the product may be presented. Also, images, video, audio and/or information may accompany the post, e.g., an image of the camera, link to list of nearby retailers that sell the product, pricing information, availability details, i.

System 120 represents a block diagram of a system for analyzing data and generating responses according to an exemplary embodiment. System 120 may include a Data Collection Module 122, a Data Processing Module 124, a Response Generation Module 126, a Tracking Module 128, a User Interface 130 and/or other modules represented by 132. These exemplary modules and interfaces are illustrative and the functions performed may be combined with that performed by other modules. Also, the functions described herein as being performed by these components may be separated and may be located or performed by other modules. Moreover, these modules and interfaces may be implemented at other components of the system 120.

At Data Collection Module 122, user generated content (events) may be received from various sources, including social media websites, networking sources, aggregators, etc. User generated content may be limited to a single source or may be retrieved from multiple sources. The user generated content may contain one or more keywords specific to the publisher's content. The user generated content may be collected, normalized, and stored from each social media's Application Programming Interface (API) in real time. The keyword that is matched may be known as the tracked keyword. User generated content may be collected from public and/or private sources. For example, a publisher may seek to respond to content from members of a professional society, association and/or club. Some marketers may provide content for users of private networking sites. Content providers may also target students who communicate and share content on a school's private networking site.

At Data Processing Module 124, user generated content may be processed, which may include filtering, classifying and/or scoring the content. The event may be filtered to remove events that meet certain conditions. For example, processing of the event may start with removal of events if they are not genuine questions by checking to see if the event contains a URL, is directed to a specific social media user, or is a copy of another event. For example, if the event is from an online social networking site or microblogging service, the event may not be processed if it contains a URL, is directed to another user (e.g., @JohnDoe), or if it is a re-posting of another user's post.

If the event does not meet those conditions, the event may be classified, where extraction of utterances and classification of speech acts may be performed by the NLP API. An embodiment of the present invention may classify an event according to various categories. For example, the event may be classified as one or more of the following: (1) States a Need/Want; (2) States a Problem; (3) Asks a Question; (4) Likes; (5) Dislikes; and (6) Discarded. Other classifications may be determined and applied. Also, new classifications may be established for each publisher so that incoming items may be processed to determine if the user generated content can be answered by the publisher's content.

The event may be assigned various scores. For example, each event may be assigned one or more of the following: a speech act confidence score, a key noun phrase score, a relevance score and an actionability score. Other scores may be applied as well. Each score may be given a numerical value between a range of 0 and 1. Other ranges (e.g., A to Z, 1-100, etc.) and/or indicators (e.g., colors, icons, etc.) may be applied.

For example, a speech act confidence score may be established with a value between 0 and 1. The speech act confidence score may represent a level of certainty that the event has been correctly classified. In other words, the higher the score the more certainty that the system has correctly classified the incoming item.

A key noun phrase may be extracted from the event and then a score may be established. If the event is not classified as Discarded, a key noun phrase or the most general topic being discussed in the text may be identified and extracted. The key noun phrase score may provide an indication that the key noun phrase in the event is the same, similar or related to the tagged keyword. For example, a high key noun phrase score may indicate that the key noun phrase of the event is very similar to the tagged keyword whereas a low key noun phrase score may indicate that the tagged keyword is marginally relevant to the event.

The NLP API may then determine one or more payloads (e.g., resources) for the event. The payload may represent content from one or more content providers. The payload may have various different formats, including URL, text, graphic, image, video, etc. An embodiment of the present invention may generate a response with the payload, reference to the payload and/or a variation thereof. For example, the response may include a combination of response text (e.g., “Here are the best reviewed digital cameras”) and URL to the content that best answers the question. For example, responses may be precompiled based on triplets (e.g., intro, topic, action) extracted from the publisher's content after being indexed by the NLP API and may then be stored in database. Also, the response may not include a payload but rather text, image, graphic, logo and/or other identifier. Other variations may be implemented.

Using the key noun phrase score and/or other score or data to filter possible payloads, a search may cause pages which are unrelated to the text of the event to be excluded from ranking. An embodiment of the present invention may display a plurality of possible payloads for use in a response. The possible payloads may be displayed in order of relevancy to the user generated content. Other rankings may also be available.

A relevancy score may provide an indication of how relevant the payload is to the user generated content. For example, the higher the score the more certain an embodiment of the present invention is that the publisher has a piece of content that is relevant to the incoming item. The relevance score may be established with a value between 0 and 1. Other ranges may be applied.

An actionability score may provide an indication of the applicability of the payload to the user generated content. The higher the score the more certain an embodiment of the present invention is that the incoming item should be responded to with the publisher's content. An actionability score may be established with a value between 0 and 1. Other ranges may be applied. This score may be determined based on the purpose of the publisher and their content and thus may be different for each publisher.

At Response Generation Module 126, using the processed data, an appropriate response may be identified and/or generated. The response may be automatically generated by an embodiment of the present invention. For example, an editor or other user may specify that for user generated content classified as a Need/Want, the system may generate automatic responses. The response may be personalized or customized for the author or originator of the user generated content. An embodiment of the present invention may also provide manual approval that may allow the response to be modified, rejected and/or approved. The response may include a link to a resource and/or the resource itself (or a variation thereof). The response may be formatted to include a shortened URL. Also, a tracking string and/or other identifier to assist in tracking the user's response may be included. The response may be provided immediately, at a deferred time, a defined time and/or in response to an event.

Tracking Module 128 may record clicks to the publisher's web site that occur on the shortened URLs to the content that appear in the response. When a user clicks on a response, the NLP API is informed of the click and records it with the response. This trains the NLP system to better issue responses based on the performance of previous responses. Tracking Module 128 may determine actions taken by the user or other user. For example, Tracking Module 128 may track whether the user makes a purchase, requests information, accesses other pages, accesses related websites, forwards the information to another user, downloads any information and/or performs any other action.

System 120 may access one or more databases, as represented by Databases 140, 142. Database 140 may contain publisher content and/or other data. Database 142 may serve as a repository for user generated content, including the associated scores and/or other analysis performed. Databases 140 and 142 may be representative of multiple storage devices, which may be located at a single location or dispersed across multiple local and/or remote locations. Also, Databases 140 and 142 may be combined into a single unit. Other variations in architecture and design may be realized.

For example, system 120 may include a flash memory, a redundant array of inexpensive disks (“RAID”), tape, disk, a storage area network (“SAN”), an Internet small computer systems interface (“iSCSI”) SAN, a Fibre Channel SAN, a common Internet File System (“CIFS”), network attached storage (“NAS”), a network file system (“NFS”), or other computer accessible storage. Also, system 120 may include one or more Internet Protocol (IP) network server and/or public switch telephone network (PSTN) server. For example, system 120 may process data requests over the communication network 110 using Internet Protocol (IP). Other storage devices may include, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

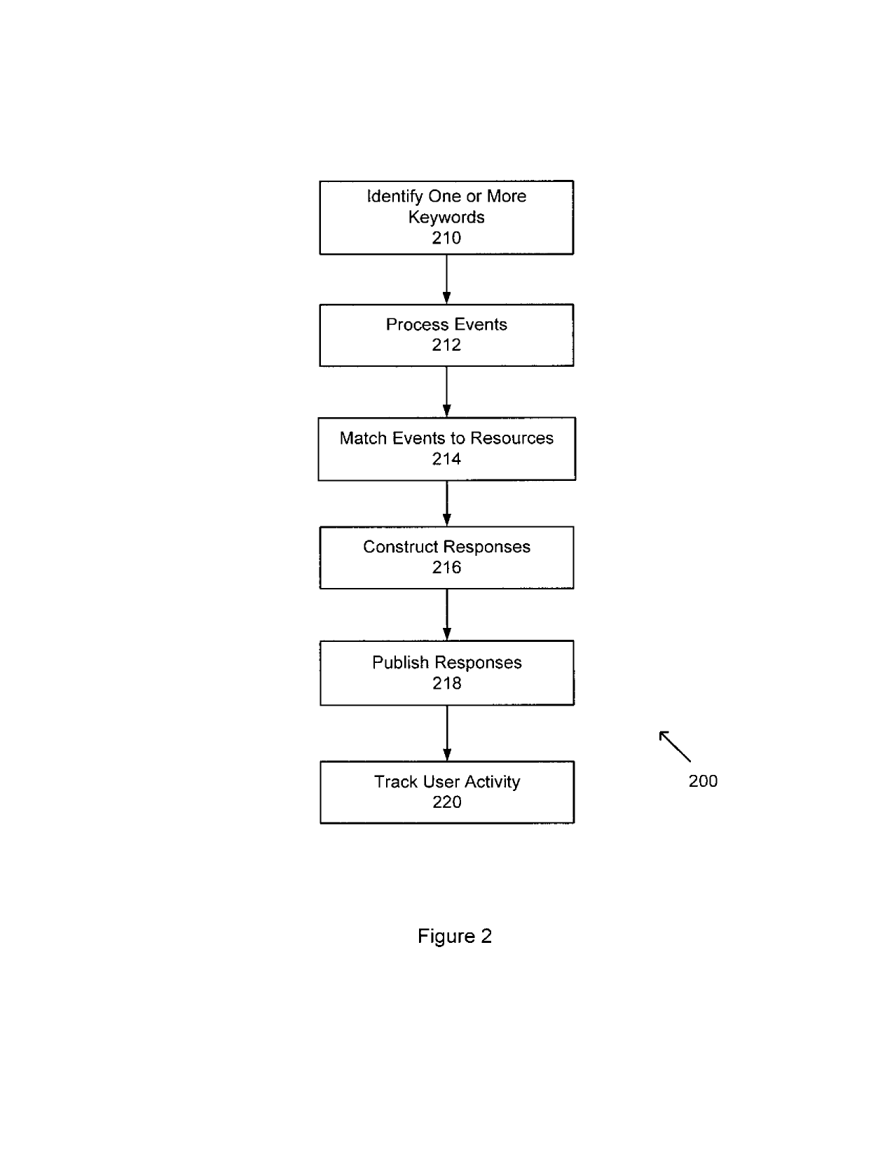

FIG. 2 is a flow chart illustrating a method of analyzing and responding to user generated content according to an embodiment of the invention. This method is provided as an example; there are a variety of ways to carry out methods disclosed herein. The method 200 shown in FIG. 2 can be executed or otherwise performed by one or a combination of various systems. The method 200 is described below as carried out by the system 100 shown in FIG. 1 by way of example, and various elements of the system 100 are referenced in explaining the example method of FIG. 2. Each block shown in FIG. 2 represents one or more processes, methods, or subroutines carried in the method 200. Referring to FIG. 2, the method 200 may begin at block 210.

At step 210, one or more keywords may be identified. For example, a content provider may specify one or more keywords related to the content provider's business or goals. The keywords may be used to collect user generated content. For example, a food/cooking publisher may identify keywords such as recipes, wine and BBQ. A consumer review company may search for consumer electronics and use keywords such as cell phone, TV and flat screen.

At step 212, user generated content may be processed, which may include classifying and scoring the content. User content may be collected and identified by keywords. An embodiment of the present invention may filter, classify and assign various scores to better identify user generated content. By accurately identifying user generated content, an appropriate response may be generated by an embodiment of the system.

At step 214, the user generated content may be matched with a resource (or payload). Using the classification and scoring algorithms of an embodiment of the present invention, one or more relevant resources may be identified for the user generated content. The resources may include links to various content and/or information responsive to the user generated content. The resource may also include text, graphics, audio, video, animations, identifiers and/or other information.

At step 216, a response may be generated. The response for the user generated content may include the resource (or payload) as well as a personalized message. The message may be customized for the user. Also, rather than including a payload, the response may be simply include information. For example, a user may post “I need a good underwater camera for my vacation.” A response may include various formats, such as a message identifying the top rated camera, a link to the top rated camera, and a picture of the camera with a short description. The response may also include a customized message for the specific user or type of user.

The response may include a URL, the response may also contain the answer directly in the response. For example, if a users asks, “What's the best LCD TV?” an embodiment of the present invention may generate a response that states “Most reviewers found that the Samsung UN55D8000 is the best 55-inch 3D LCD TV by far.” This will provide a rich experience for the user as they will not have to click through to the content to find the answer since the answer is sent directly to them.

An embodiment of the present invention may be used in a manual or automated mode and may send responses in rapid succession to multiple users. The system of an embodiment of the present invention may feature functionality that allows for various delays between event post, reply, and frequency of response to the same individual to determine the timeframe and frequency of responses desirable for people posting questions. Also, a time of day for sending responses may be identified. An embodiment of the present invention may further limit the number of responses for a specific user, e.g., 1 response per week, 1 response every 20 posts, etc. The system may send responses automatically for a set period of time, e.g., 9 am to 5 pm, when administrative supervision is available.

Also, the system may reserve responses from certain users, such as highly influential users, celebrities, etc., for administrative review and customization. An embodiment of the present invention may flag certain replies for editorial reviews. For example, the system may recognize that people participating in social media networks have various degrees of influence as determined by the size of their social network, how widely their content is distributed throughout the network, and/or other factors. An embodiment of the present invention may flag responses to highly influential users by marking the replies for manual editorial review before sending the response. This may allow the publisher to craft a reply that establishes a direct connection to the influential user.

In addition, by gathering data across social media contexts, an embodiment of the present invention may rank incoming social media events by importance determined by various facets including, total number of connections (e.g., friends/followers), engagement levels (e.g., number and quality of recent posts), sentiment analysis (e.g., general disposition of the users posts) and other aspects of a users social networks.

An embodiment of the present invention may recognize a user's current location, desired location and/or relevant location information as determined or mentioned by the user's comment or post. For example, physical location may be taken into account for posts containing location-specific queries (e.g., “Where can I find a good TV in New York City?”). Other examples may include: “Visiting DC for the first time, any recommendations for hotels and restaurants?” Also, location information may be determined by extracting the latitude and longitude information from a post containing such information. As such, responses to such posts may contain location specific domains. For example, a user may simply post “Enjoying the city tonight, I'm craving a good cheeseburger!”—without mention of a location. An embodiment of the present invention may recognize the user's location and generate a response with recommendations within 5 blocks of the current location. The response may also include a map, directions, menu and/or other information. For example, the response may state: “Try Bob's Burger Place—just 5 minutes away. Here's a map with directions.” An embodiment of the present invention may also identify whether the customer is walking, driving or taking a different form of transportation (e.g., subway, etc.), and then cater the response. If the customer is in a car, the top recommendations within a 3 mile radius may be provided whereas if the customer is walking, recommendations within a 5 block radius may shown. If the customer is on a subway system, the system may provide recommendations at the next 3 stops in advance of the current stop.

At step 218, the responses may be published or otherwise made available to the user. The response may be posted to the appropriate social networking website in response to the user generated content. Also, the response may also be sent as a private message or other electronic communication to the user and/or the user's followings, friends, associates, etc. The response may also be sent as a text message, a voicemail and/or other form of communication. Moreover, the response may be sent via multiple communication methods, e.g., responsive post and text message. For example, an embodiment of the present invention may send directions, a menu and/or a map via a text message or other mode of communication. The user may also specify preferred methods of communication. For example, if the user generated content includes the words “Help,” “Urgent” or the entire message is in all capital letters, an embodiment of the present invention may recognize the need to respond quickly and also respond via multiple modes of communication.

At step 220, the responses may be tracked for user interaction. An embodiment of the present invention may track user activity, such as click through activity, and/or other user action in relation to the response.

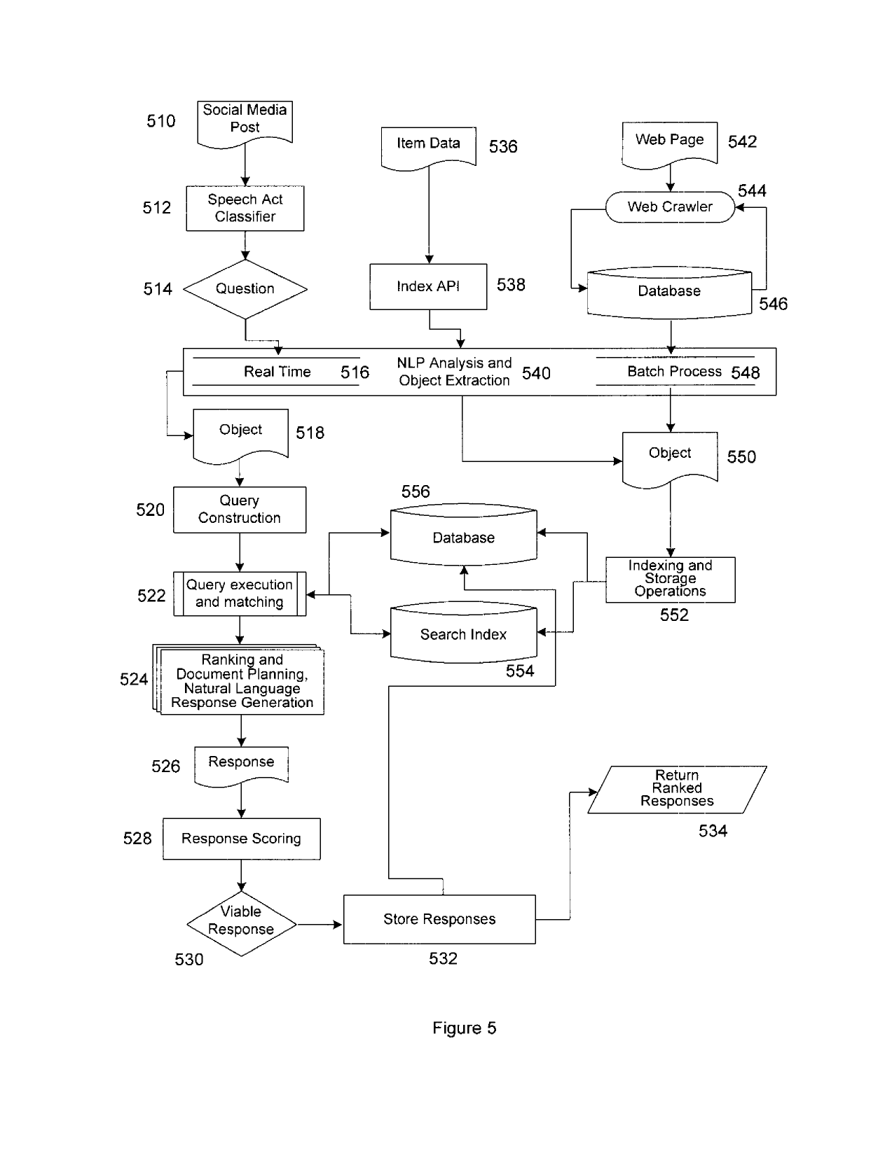

An embodiment of the present invention may track the effect of issued responses by monitoring click through rates from custom URLs containing tracking codes issues to given users. The system may track and trend the effectiveness of a response based on how well a user clicking through monetizes on the target web site. This data may be fed back into a NLG systems (see FIG. 5 below) as well as the NLP systems and may be used for supervised training of artificially intelligent sub subsystems. A portable library may be made available for installation on the publisher's website that may send data to the system as the user interacts with the content. Data collected may include but is not limited to; page views; clicks on content, outgoing links, advertisements; time on site, etc. This data may be made available to publishers and/or other users so that they can measure the performance and return on investment of their replies and use of the system. The system may also detect when purchases are made from the page, what other users click on the page, whether the user forwards the link and/or performs other action in response. The user activity may be used to determine usefulness of the response and payload and further used to refine the system.

An embodiment of the present invention provides the ability to have a conversation with users, where a user may respond to the response with a question, statement, comment, etc. For example, the user may post: “I need a new blender!” An embodiment of the present invention may respond with a link to the best 5 blenders. The user may respond: “Great, thanks. also need a new toaster. Can I have a list for that?” The system may then provide a link to the best 5 toasters.

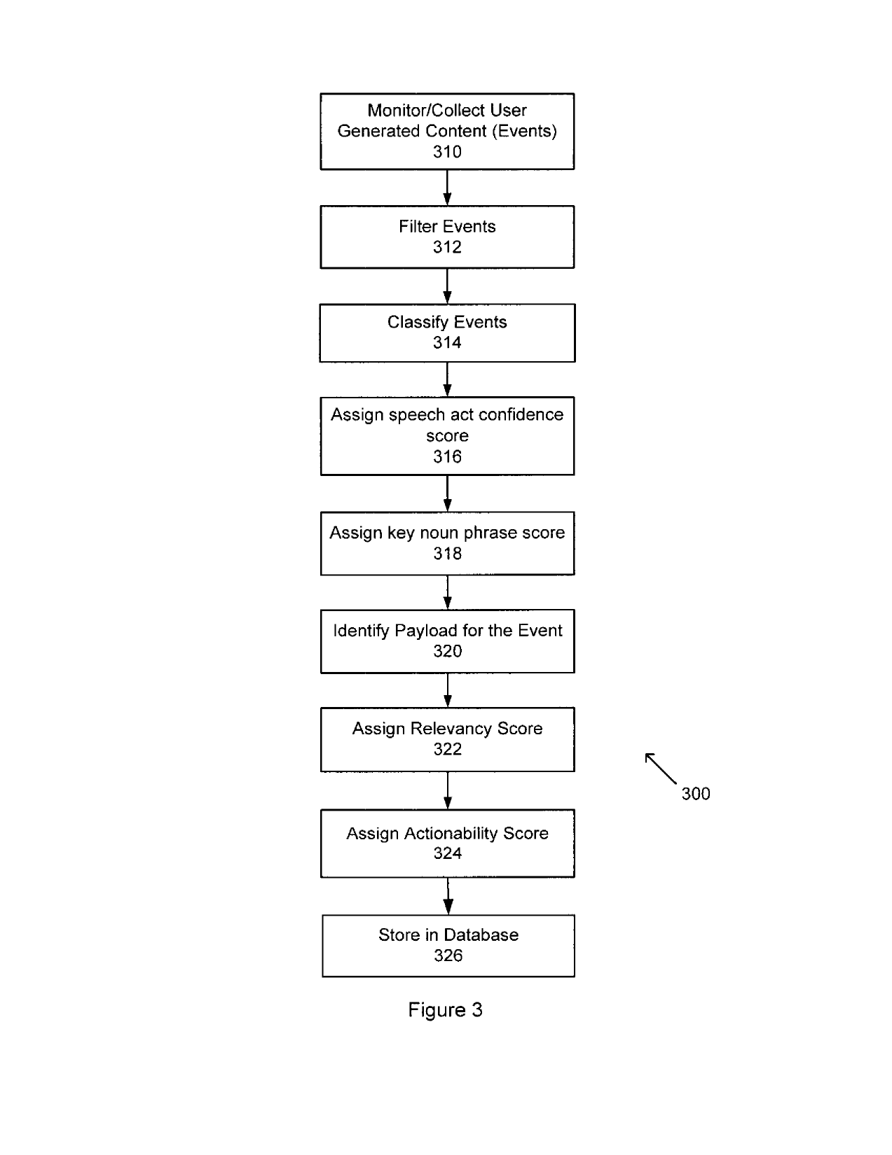

FIG. 3 is a flow chart illustrating a method of classifying user generated content according to an embodiment of the invention. This method is provided as an example; there are a variety of ways to carry out methods disclosed herein. The method 300 shown in FIG. 3 can be executed or otherwise performed by one or a combination of various systems. The method 300 is described below as carried out by the system 100 shown in FIG. 1 by way of example, and various elements of the system 100 are referenced in explaining the example method of FIG. 3. Each block shown in FIG. 1 represents one or more processes, methods, or subroutines carried in the method 300. Referring to FIG. 3, the method 300 may begin at block 310.

At step 310, user generated content may be monitored and collected. Such content may be collected from various networking sites. An embodiment of the present invention may gather content from a single source or a combination of various sources.

At step 312, the user generated content may be filtered. An initial filtering of the data collected may involve discarding content that meets or does not meet certain criteria. For example, certain types of content may be excluded, such as content containing a URL, is directed to a specific user thereby implying a response is not welcomed from other sources or if the content is merely a copy of another user's post. Other filters may be applied. For example, a certain content provider may desire to respond to user generated content directed to a particular model of electronics to the exclusion of others. Another content provider may want to avoid certain politically charged topics. Also, any posts with profanity and other negative language may be filtered out of the process. In addition, the system may recognize unique phrases that should be filtered out. For example, some phrases appear to be questions but are really quotes from slogans or tag lines from popular commercials and advertisements as well as terms or phrases made popular by celebrities.

At step 314, the user generated content may be classified to identify the type of event. For example, the categories may include one or more of the following: States a Need/Want; States a Problem; Asks a Question; Likes; Dislikes; and Discarded. Also, classifications may be determined by the content provider, publisher and/or other entity. Additional classifications may be established for each publisher. For example, a user may post “I really like my Brand A television, I hope my next one is Brand A.” This post may be classified as a ‘like” and a possible response may be “When you're ready to buy, these Brand A televisions were rated the best.” If content does not match any of categories, the user generated content may be classified as Discarded.

The event may be assigned various scores. For example, each event may be assigned one or more of the following: a speech act confidence score, a key noun phrase score, a relevance score and an actionability score. Other scores may be applied as well. Each score may be given a numerical value between a range of 0 and 1. Other ranges and/or indicators may be applied.

At step 316, a speech act confidence score may be assigned to the user generated content. The speech act confidence score may be representative of a level of confidence that the content has been correctly classified.

At step 318, a key noun phrase score may be assigned. For example, for each user generated content, a key noun phrase or a general topic discussed may be identified and extracted. A key noun phrase score may be representative of the level of confidence that the key noun phrase of the user generated content matches the tagged keyword. For example, the phrase “I really can't stand my phone” may be associated with “phone” which may be matched with the tagged keyword “cell phone.”

At step 320, an appropriate payload may be identified for the user generated content. According to an exemplary embodiment, the NLP API may determine which payload may be suited for the event. A payload may be a combination of response text and URL to the content that best answers the question. Using the key noun phrase score (or other factor) to filter possible payloads, the search may cause pages which are not about the text of the event to be excluded from ranking.

At step 322, a relevancy score may be assigned. The relevance score may be representative of the confidence that a publisher has a piece of content that is relevant to the incoming item.

At step 324, an actionability score may be assigned. The actionability score may be representative of the confidence that the incoming item should be responded to with the publisher's content. This score may be determined based on the purpose of the publisher and their content and thus can be different for each publisher. For example, a publisher that writes product reviews has content that is best suited for helping users find the product that is right for them. Therefore, an actionable item may be one in which a social media user is asking for advice on which product to buy. A publisher that writes content about healthy living, however, may define actionability as a social media user asking for advice on improving their health in a variety of ways. Actionability, therefore, may be customized for each publisher in the system by way of natural language processing to examine both the intent of social media users and the content created by the publisher. For example, if a user posts “I really love my hair color,” actionability may be low for a product review content provider.

At step 326, the scores and associated data for each user generated content may be stored in a database.

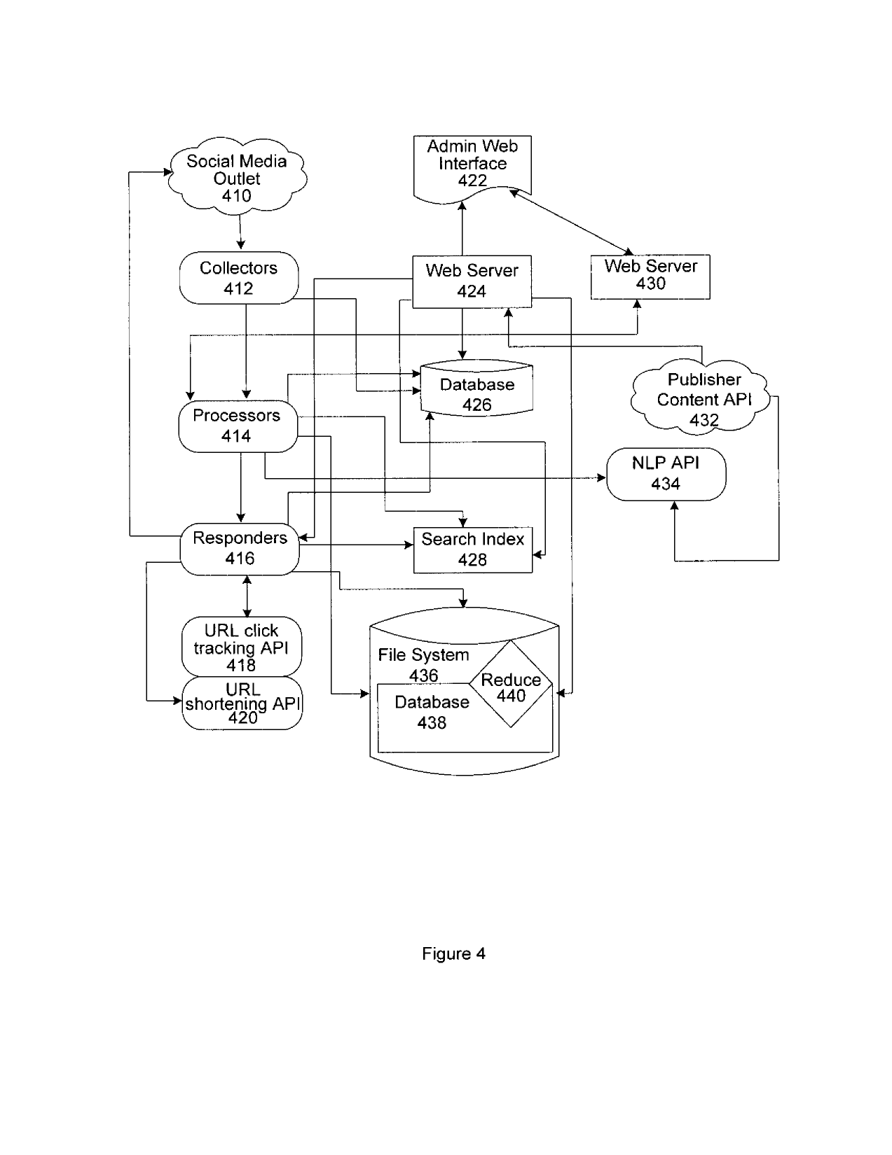

FIG. 4 illustrates a block diagram of an exemplary system architecture, according to an embodiment of the present invention. The system of an embodiment of the present invention provides scalability, fault tolerance, and low latency. As shown in FIG. 4, its construction is modular and composed of independently scaleable sub systems interoperably connected.

Social media outlet 410 may be in communication with data collections, such as one or more collectors, represented by 412. An embodiment of the present invention may fetch events from social media platforms that provide an API. There are other social networks that do not provide an API but rather whose content and data may be viewed and processed. An embodiment of the present invention may connect to non-API platforms by reading and collecting content from the website, processing and analyzing the data to determine if the data includes events to which an embodiment of the present invention can respond and then automatically submit replies. Thus, an embodiment of the present invention may find and answer any question posed by a user anywhere on the Internet, resulting in a significant amount of active and engaged users to visit the publisher's web site to read the answer or response to various question and posts.

User generated content (or event) that contains keywords specific to the publisher's content may be collected, normalized, and stored from each social media. This may occur via an API in real time or other methodology. Data from social media outlet 410 may be streamed in real-time to collectors 412. An embodiment of the present invention may use a management process that may spawn off a thread to handle each feed independently. The framework may automatically cluster the data collection based on a current load of a feed machine. The collectors may filter out non-relevant events and split the stream into small events which may be placed on a load balanced queue, such as a parallel task ventilation queue. The contents of the queue may be stored in memory, such as RAM. The collectors may periodically spawn various batch oriented tasks including statistical jobs, shown by Reduce Module 440, on a File System 436 cluster and sync keywords from Database 426 to the collectors 412 controlling the filters applied to the social streams. Reduce Module 440 may represent a programming model for processing large sets of data. Additional jobs may synchronize real-time data from the Database 438 to Database 426 for summary sorting. Other processing, sorting and/or analysis may be performed.

Natural Language Processor (“NLP”) Application Programming Interface (“API”) 434 may perform real-time classification and matching of events. It may be accessed through a blocking API call from processor 414, for example.

Processors 414 may be configured on database 426 and a management process may spawn off as many child threads as can be accomplished with the hardware available by the machine as well according to defined host based maximums. In addition, processors 414 may auto cluster. In other words, each thread may connect to its feeds task queue through sockets and/or connectors and when an event is pushed onto its queue, it may begin processing.

The processing of user generated content may involve filtering, classifying and/or assigning scores. Based on the processing, a relevant payload and/or response may be generated and matched with the user generated content.

Data may then be stored in Database 438 and real-time counters for keyword, payload match, URL match counts, and various charts may be automatically incremented. The event may be indexed in Search Index 428, and if the event is ranked relevant, actionable, and correctly classified a connection may be made to Web Server 430 for real-time user notification on the Admin Web Interface 422. An embodiment of the present invention may be configured to automatically reply to events matching certain floor thresholds, where the event may also be routed to Responders 416.

Responders 416 may receive events from web applications 422 via Web Server 424 and from Processors 414. URL Shortening API 420 may be used to compact long form URLs before a response is issued. Once an event and its response payload are analyzed for long URLs which need to be shortened through the URL shortening API 420, these URLs may be tagged with a tracking query string used to feed data back to the system as the user interacts with the publisher's website. An embodiment of the present invention may provide tracking capabilities. For example, URL click tracking API 418 may provide a data stream which may notify the system of a click on a link sent by the Responders 416. Also, Responders 416 may receive click events from the URL click tracking API 418. These clicks may be stored and trended in Database 438 and further indexed in Search Index 428, and feedback data may be sent to the NLP API about the effectiveness of a given response. Other user actions may be tracked as well.

Additionally, an event may be sent to the Web Server 430 for real-time user notification. Web Server 430 may provide user management, feed management, searching through the data, viewing responses, viewing clicks, and/or issuing manual responses. An embodiment of the present invention may be designed to interact with real-time data feeds. Application settings and feed configuration data may be stored in Database 426, and search functionality may be executed against Search Index 428. The application also exposes an API for indexing keywords in bulk from any external source, such as Publisher Content API 432. Content from various content providers may be collected at 432, the content may be processed and/or indexed and then stored.

Web Server 430 may connect to an Admin Web Interface 422 and to Processor 414. It may transmit data from the backend to the front end in real-time.

File System 436 may store data created by an embodiment of the present invention. File System 436 may represent a distributed file system that abstracts data replication and may be used as the base for database 438. Database 438 may store the bulk of the data collected by the system. It may be a column oriented document store, for example, which may achieve web scale without compromising performance. Various techniques may be used to achieve high throughput and fast random reads, which may be based on designing the keys used to store data to guarantee data locality and highly performance sequential scans.

Reduce Module 440 may be executed against Database 438 to compute statistics and summary information. Reduce Module 440 may allow an entire corpus, or subset thereof, of collected events to be quickly analyzed from within Database 438. This allows difficult problems to be parallelized and thus accomplishable at scale.

According to an exemplary embodiment, full text data may be exported through the Publisher Content API 432 directly to the NLP API 434 and Admin Web Interface 422 (via Web Server 424). This may represent the core data used to calculate relevance score.

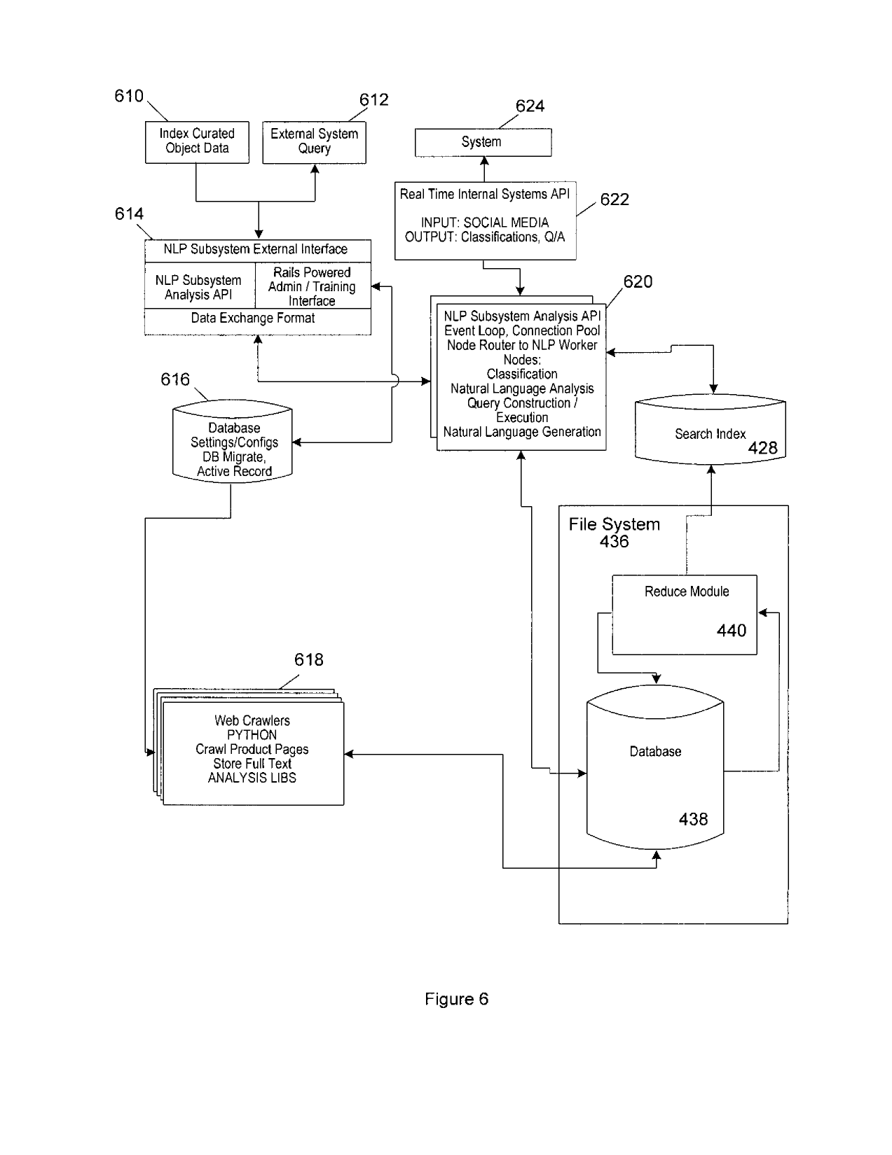

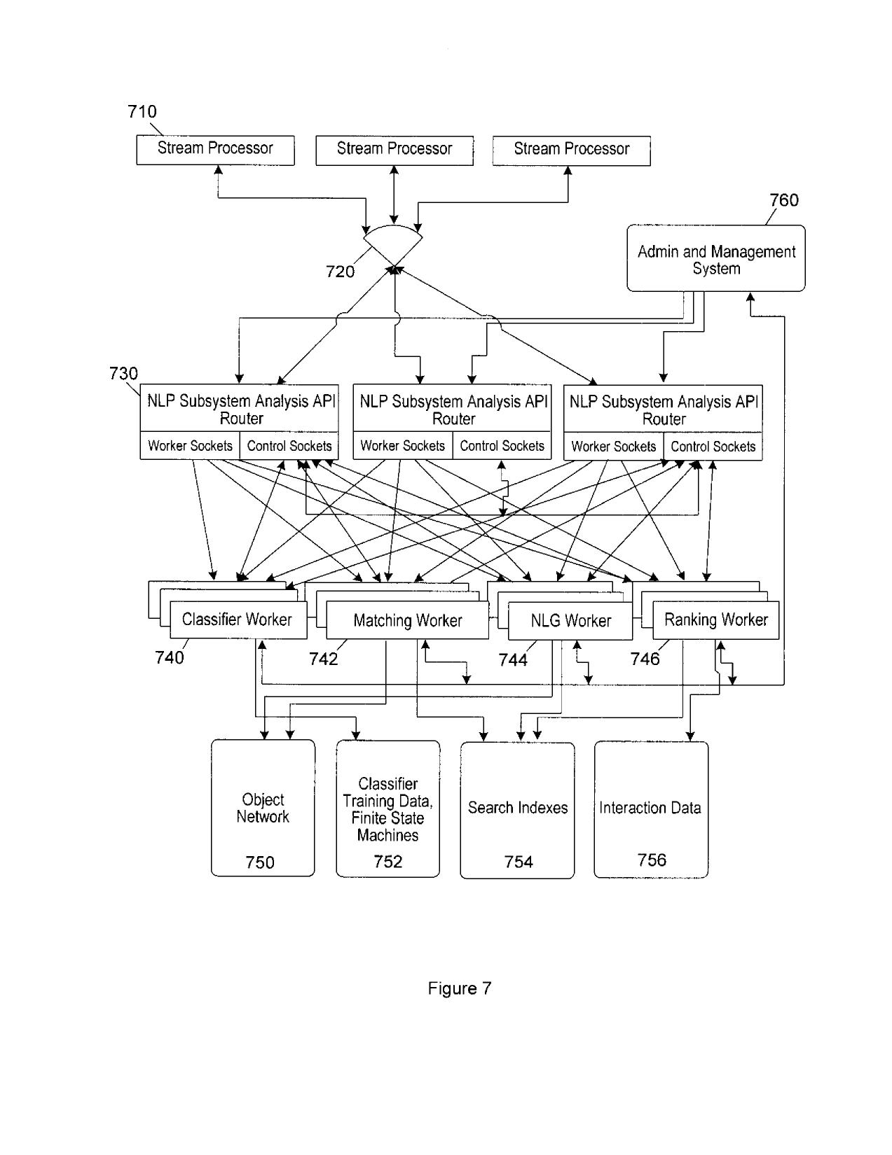

About Language Processing Service (ALPS) process diagram is shown in FIG. 5, ALPS API architecture diagram shown in FIG. 6, and components of a non-blocking NLP analysis API subsystem shown in FIG. 7 may establish the process by which an embodiment of the present invention may generate replies. Other architectures and processes may be implemented.

FIG. 5 is an exemplary flowchart for generating and enhancing responses, according to an embodiment of the present invention. For example, generation of response text may be performed using triplet processing of publisher content. However, this may create a limitation in the connection between the text of the event and the response because the response text is derived from the content and not the language of the event. An embodiment of the present invention may be directed to enhancing response generation by implementing a Natural Language Generation (NLG) API, as shown in FIG. 5, to create natural language responses that are directly related to not only the event text (“My laptop is really slow. Can anyone recommend a laptop?”) but also the personality and behavior of the social media user. As shown in FIG. 5, an embodiment of the present invention may connect to the social media API, as illustrated by 510, and retrieve the last one hundred posts (or other number or subset of posts) by the user and perform natural language processing analysis to determine the interests and sentiment of the user over time. The user's posts and/or other form of user expression may be analyzed, including emails, voicemails and/or other user originated content from other sources. A user's likes, dislikes, interests, taste in music, involvement in organizations and charity work may also provide insight into the user's personality and sentiment. An embodiment of the present invention may determine, for example, that the user generally writes in a positive manner and likes to travel, and then generate a natural language reply that answers the users question in a contextual manner (e.g., “These are the best laptops that are blazingly fast and easy to carry while traveling.”). Responses may be built from data extracted about a given piece of content in the object network in ALPS. This response may be ranked according to various aspects including its grammatical correctness, similarity to previous responses, the success of those previous responses, how its sentiment relates to the original posting, as well as other factors. Top ranking responses may be automatically issued to the originating social network users account through that social networks internal messaging systems. Success of a given response may be tracked and trended by monitoring click through events to attached links as well as user interaction on the publisher's website.

As shown in FIG. 5, user generated content from a social networking site may be collected, at 510. A speech classifier may be applied to the user generated content at 512. If the content is determined to be a question that an embodiment of the present invention may provide an answer to, NLP Analysis and Object Extraction 540 may be performed which may receive data in real time, as shown by 516, and by batch process, as shown by 548. An object may be identified at 518 and a query may be constructed at 520. Query execution and matching may be performed at 522. An embodiment of the present invention may then generate a response, as shown by 524. A response may be created at 526 and also scored at 528. If the response is deemed to be viable, at 530, the response may be stored at 532 and one or more ranked responses may be identified and displayed at 534. The responses may be stored in object network database 556.

Item data 536 may be representative of content provided by various content providers. An Index API 538 may collected and provides an index to the item data, at 538. NLP analysis and object extraction may be performed at 540. The object 550 may be indexed at 552 and then stored in object network database 556 with an index identified at Search Index 554.

Data from various sites, represented by Web Page 542, may be collected via a tool, such as Web crawler 544, and stored in database 546. Data may be received by batch process at 548 and object data may be extracted at 550. The object 550 may be indexed at 552 and then stored in object network database 556 with an index identified at Search Index 554.

As shown in FIG. 5, NLP Analysis and Object Extraction 540 may use real time processing at 516 and/or batch processing at 548. For example, an embodiment of the present invention may be reliant on real time data feeds such as a microblogs and/or other types of feeds. Those feeds may be consumed in real time. Other portions of the NLP systems may rely on batches of data. In the exemplary case of web crawlers, data pages may be received as a batch feed to the system, where objects, such as 518 and 550 may be extracted and derived from raw text. The derived objects may then be used during matching and query time to provide the data to the real time NLG subsystems for response generation. In such cases, raw text may be received as a feed into the system, which may derive objects entities from the raw text through the use of, but not limited to, finite state machines, statistical classification methods, search algorithms, reverse indexes derived from the existing object network, regular expression based extraction, and other context free grammars. For example, inputting “I really need a new car” to the real time system may extract “car” as one object. Inputting an article about cars via batch process may extract features about the “car” object class in general and populate data into the object network's hierarchical structure. To further illustrate, cars of a certain make or model may be extracted from raw text and then details about those specific makes and models may be recursively defined from additional text from the article and/or through other data points and relationships in the object network, e.g., inheritance, deduction, induction, contradiction, exhaustion, probability or similar logical proofs. Once objects are extracted for the real time process, the extracted objects may be used as primary facets for search and ranking algorithms which serve to define a definitive domain for additional real time logical analysis. Once objects are extracted during batch insertions, the extracted objects may be indexed in the object network preserving and/or deriving new relationships to other objects.

FIG. 6 illustrates a language processing services architecture for generating responses, according to an embodiment of the present invention. FIG. 6 is a topology of a system for implementing the logical process illustrated in FIG. 5 above. An embodiment of the present invention may return personality search results. Search engine technology scans content and counts how many times words appear on a given page, how many other web sites link to that page and a ranged of other factors that are used to determine content quality and placement within results. An embodiment of the present invention may expand on this by scanning each sentence in the document and performing natural language analysis of the sentences to determine what each sentence is describing and how it is being described. These grammar factors become facets for the document. When a user performs a query, an embodiment of the present invention may return results that match the personality of the user by looking for facets in its document index with facets determined from scanning content created by the user over time. This technology may be provided to content publishers through the ALPS API, illustrated in FIG. 6.

As shown in FIG. 6, index curated object data 610 and external system query 612 may be accessed by an external interface, shown by 614. Database 616 is connected to web crawlers, represented by 618. User interface may be illustrated at system 624 and user generated content from social media and other sites may be collected and classified, at 622. Responses may be generated at API 620 based on the classification of data. File System 436 may communicate with Search Index 428 and further communicate with API 620 and Web Crawlers 618.

API 620 may also provide sentiment analysis. For example, objects in the Object Network may be analyzed for sentiment. This data enables the system to automatically determine the general perception of a given entity. This may include data from web crawls, social media, and others. Analysis may occur in both real time and through batch processes depending on the data source.

FIG. 7 illustrates an exemplary language processing services API, according to an embodiment of the present invention. The Language Processing Services API provides an external interface allowing applications and services to classify natural language, match queries to resources, and/or construct responses in natural language. An exemplary architecture, shown in FIG. 7 is modular and designed to provide high availability and scaleability. Requests for processing may be submitted from stream processors, shown as 710, through the interfaces in a load balanced fashion, represented by Load Balancer 720. Other processors may be used. Routers, shown by 730, may represent high speed routing devices that take advantage of the non-blocking nature of I/O requests. In this example, Routers may be NLP Subsystem Analysis API Routers. Routers 730 may then submit requests for classification over connections to classification worker nodes, as shown by 740. Multiple requests for classification may be submitted simultaneously to different classifier nodes which implement a variety of classification algorithms based on different training data and models, as shown by 752. Once classification is complete, relevant social media posts may be submitted to matching workers 742 for relevance analysis. Social media posts may be matched against features extracted from full text web documents, as well as curated data indexed into the object network 750 using various search indexes 754, frequency data, and pattern matching. Matching documents may then be submitted in parallel to Natural Language Generation (NLG) workers 744 for response text generation. Responses from workers may be collected and candidate responses may be submitted for ranking analysis to ranking workers 746. Candidate responses may be ranked according to a variety of algorithms taking into account previous positive re-enforcement of similar responses to determine the most accurate response possible, as shown by 756. Ranking workers 746 may return a ranked list of top candidate responses to routers 730 which may then issue the request which in turn returns a response to stream processors 710. Language processing services cluster state and route configurations may be configured in real time based on current cluster node load through the control sockets. Control sockets allow for process nodes to operate in a transient and on-demand way, keeping the cluster highly responsive by routing process requests to nodes which have the capacity to service the request.

New routes may be automatically exposed through the worker registration process, for example. Routes (e.g., http resource paths) exposed to external queries may be defined in several exemplary ways. For example, a route may be configured on the NLP Subsystem Analysis API front end through hardcoding, configuration file, database resource, a route may also be added from a backend worker at run time. This gives the front end real time flexibility with what resources are exposed externally through resource paths, and which requests may be routed to backend processing subsystems. This allows the system to reconfigure itself “on the fly” without the need to recode front end devices and/or restart operational systems. During the worker registration process, new workers may be started on backend servers which then self-identify and “register” with frontend service brokers and routers, allowing new service process paths to become available in real time as workers are added to the system. If multiple workers are registering for the same service routers, broker systems automatically load balance requests among the registered workers.

An embodiment of the present invention provides administrative and management functions. For example, an administrative web interface shown by Admin and Management System 760 may provide functionality for administrators, managers, editors and/or other users. Each publisher may have their own administrative web site. For example, editors may perform various functions, such as view items, view item classification, send replies, and view metrics. Managers may have the same or similar permissions as Editors and may also be able to adjust settings for automatic responding. Administrators may have the same or similar permissions as Managers and may also be able to manage users, tracked keywords, sources, and server configuration options.

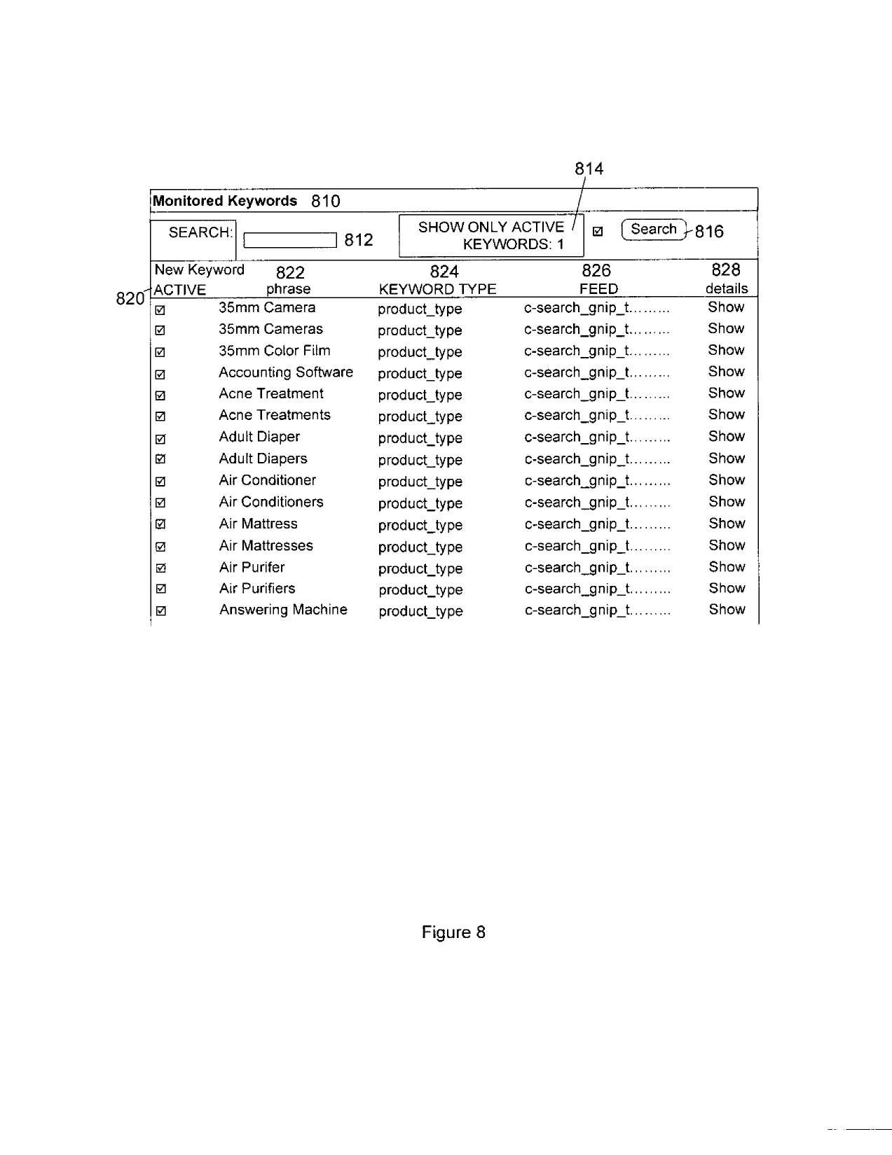

FIG. 8 is an exemplary screenshot illustrating monitored keywords, according to an embodiment of the present invention. To receive user generated content from social media platforms, an administrative user may first configure which keywords should be monitored on those platforms. The Monitored Keywords view 810 allows Administrative users to add new keywords, enable and disable keywords, and search for configured keywords. A search term may be inputted at 812 and a search function may be executed at 816. In this example, only active keywords are displayed, as shown by 814. Active 820 indicates whether the keyword is active or not, Phrase 822 provides the monitored keyword, Keyword Type 825 indicates the category or type of keyword. In this example, the keywords displayed refer to products. Feed 826 provides a source of the data.

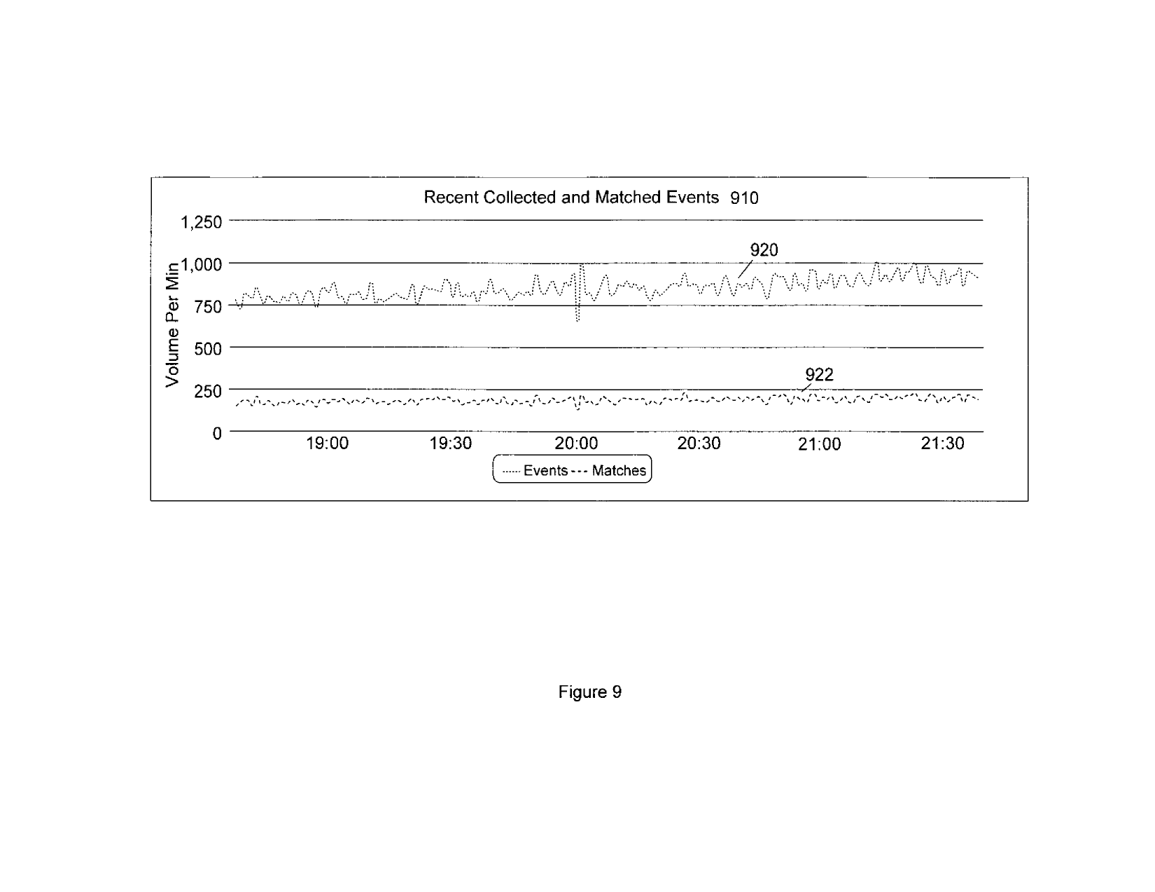

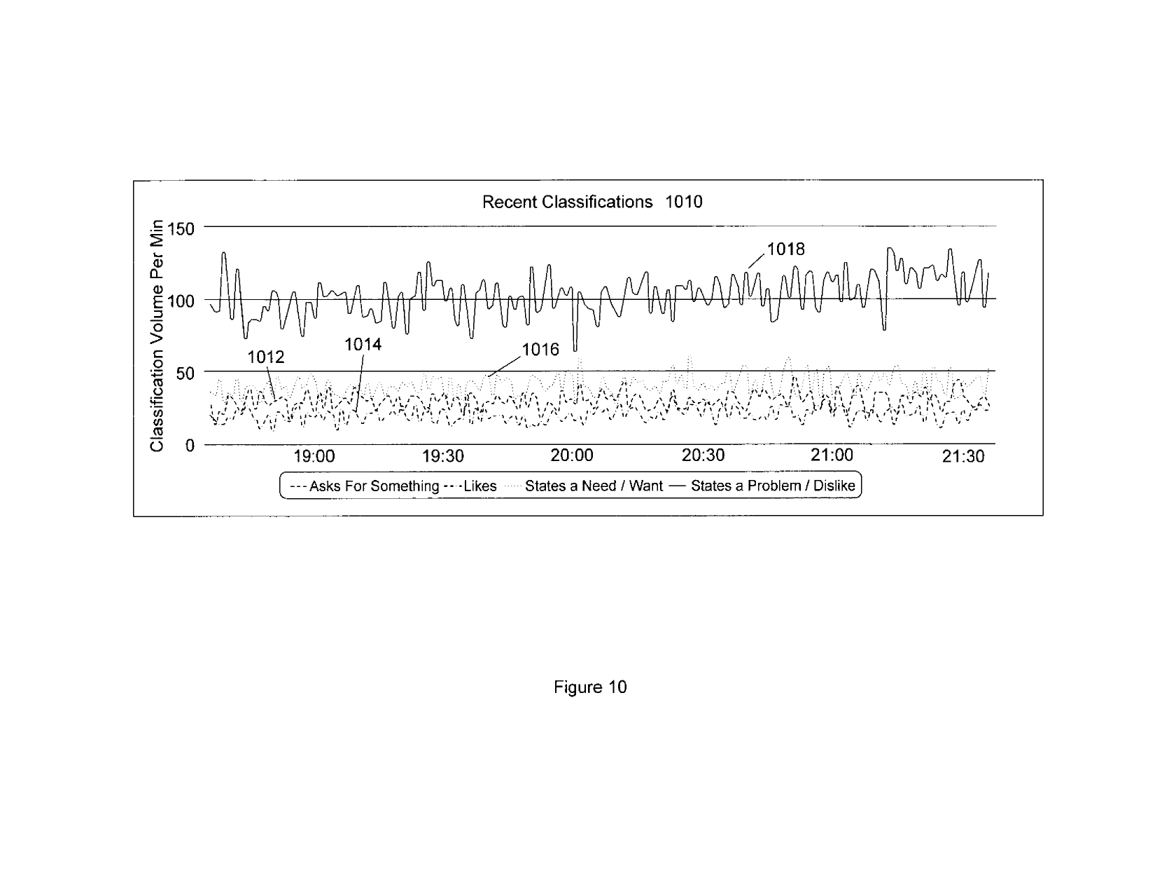

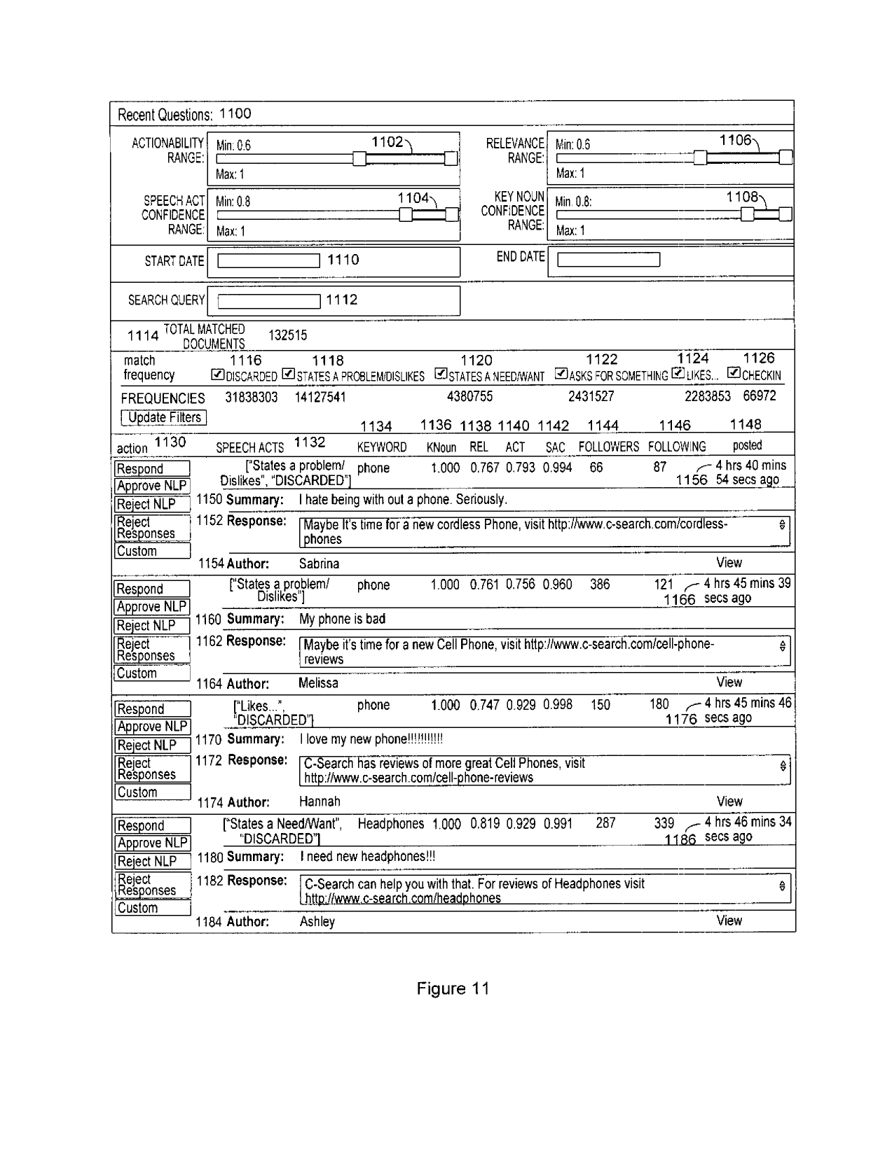

Additional details may be displayed from FIG. 8. For example, by selecting “Show” under 828, details about that keyword may be displayed, such as collection statistics shown in FIG. 9, speech act statistics shown in FIG. 10, and Questions view shown in FIG. 11 displays social media items that contain that keyword.

FIG. 9 is an exemplary screen shot illustrating recent collected and matched events, according to an embodiment of the present invention. The Recent Collected and Matched Events graph 910 displays the number of user generated content events 920 and matches collected 922 over a period of time. In this example, Events 920 may represent statistics before any natural language processing has been performed on items whereas Matches 922 may represent events that were classified through the natural language processing API.

FIG. 10 is an exemplary screen shot illustrating recent classifications, according to an embodiment of the present invention. FIG. 10 is an exemplary Speech Act graph that displays the number of classified events from the natural language processing API. An Editor user may select the timeframe and view an updated graph of recent classifications, shown by 1010. Each line may represent a national language processor (NLP) classification. In this case, the graph displays the number of user generated content events from a social networking source that have been classified as “Asks for Something” 1012, “Likes” 1014, “States a Need/Want” 1016 and “States a Problem/Dislike” 1018.

FIG. 11 is an exemplary screen shot illustrating a questions view, according to an embodiment of the present invention. According to an embodiment of the present invention, an administrative user may respond to items manually using a Recent Questions view 1100. This view allows the user to filter events based on actionability, relevance, speech act confidence, key noun phrase confidence, date, search query, and/or classification. In this example, an actionability range is shown by 1102, a speech act confidence range is shown by 1104, a relevance range is shown by 1106 and a key noun phrase confidence range is shown by 1108. Additional filtering criteria may be considered, such as Start Date 1110 and Search Query 1112. A number of total matched documents may be shown at 1114. Also, the number of matches may be further broken down by categories, as shown by Discarded 1116, States a Problem/Dislikes 1118, States a Need/Want 1120, Asks for Something 1122, Likes 1124 and Check In 1126.

The user may view details about the matched Keyword, or view the individual event. As shown in FIG. 11, for each match, various characteristics may be shown, such as speech act 1132, keyword 1134, key noun phrase score 1136, Relevancy Score 1138, Actionability Score 1140, Speech Act Score 1142, number of followers 1144, number of following 1146 and posted time 1148. In this example, a summary may be shown at 1150, a response at 1152, and an author identifier 1154 and posted time 1156. The next match may have similar data displayed, including summary at 1160, response at 1162, author identifier at 1164 and posted time at 1166. in the next match similar data displayed, including summary at 1170, response at 1172, author identifier at 1174 and posted time at 1176. Finally, the last match on this exemplary page may display summary at 1180, response at 1182, author identifier at 1184 and posted time at 1186.

For each event, administrative users may choose to Respond, Approve NLP classification, Reject NLP classification, Reject Responses, and/or generate a Custom response, as shown by 1130. For example, to send out a response quickly, users may choose the desired response from a select list, then click the “Respond” button. Other variations of the details shown in FIG. 11 may be displayed.

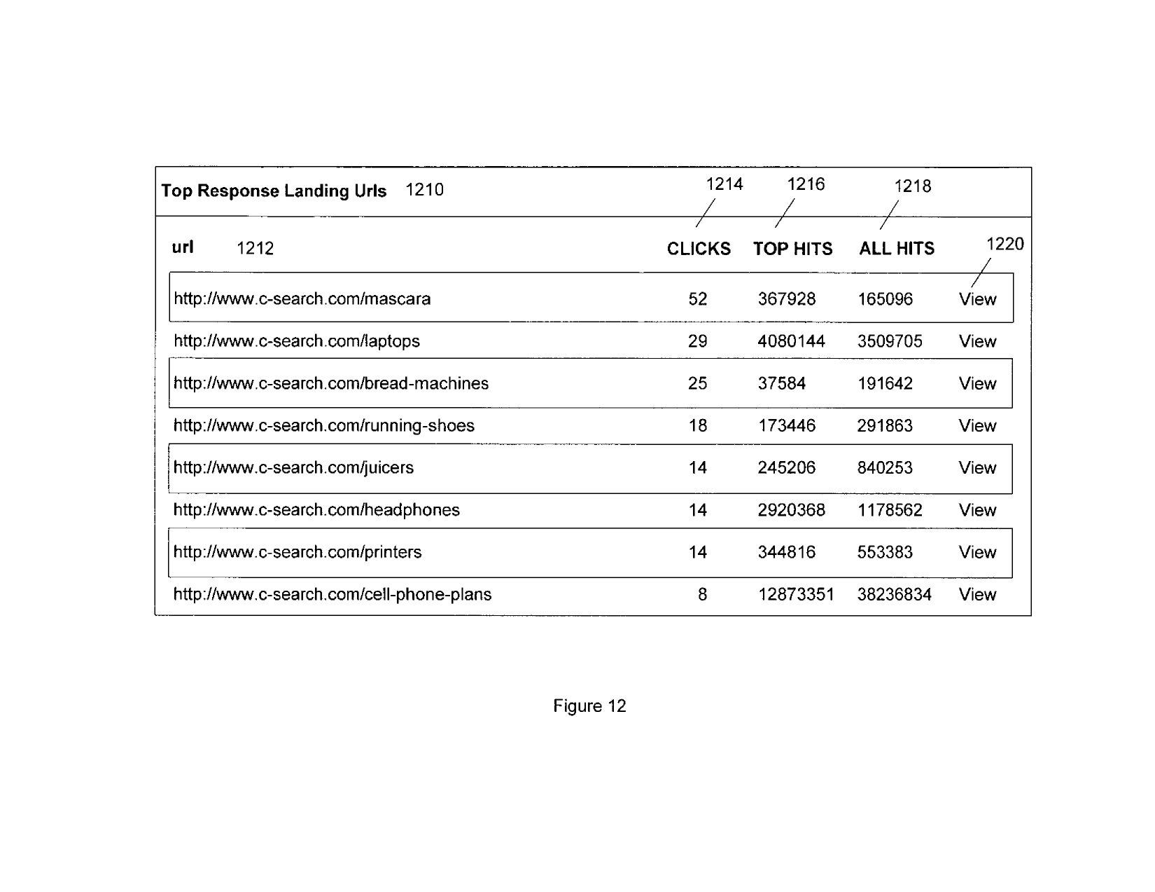

FIG. 12 is an exemplary screen shot illustrating top response landing URLs, according to an embodiment of the present invention. The Top Response Landing URLs table 1210 may display pages that were included in responses sorted by most amount of clicks received. In this example, URLs may be identified at 1212 with a corresponding number of clicks at 1214. Other information displayed may include “top hits” 1216 which may represent total number of times that the URL was determined to be the best URL to include in a response, and “all hits” 1218 which is the total number of times that the URL was included in the top candidate URLs (e.g., top 5 URLs, etc.) for a response. Additional details may be viewed by selecting 1220. Other variations of the details shown in FIG. 12 may be displayed.

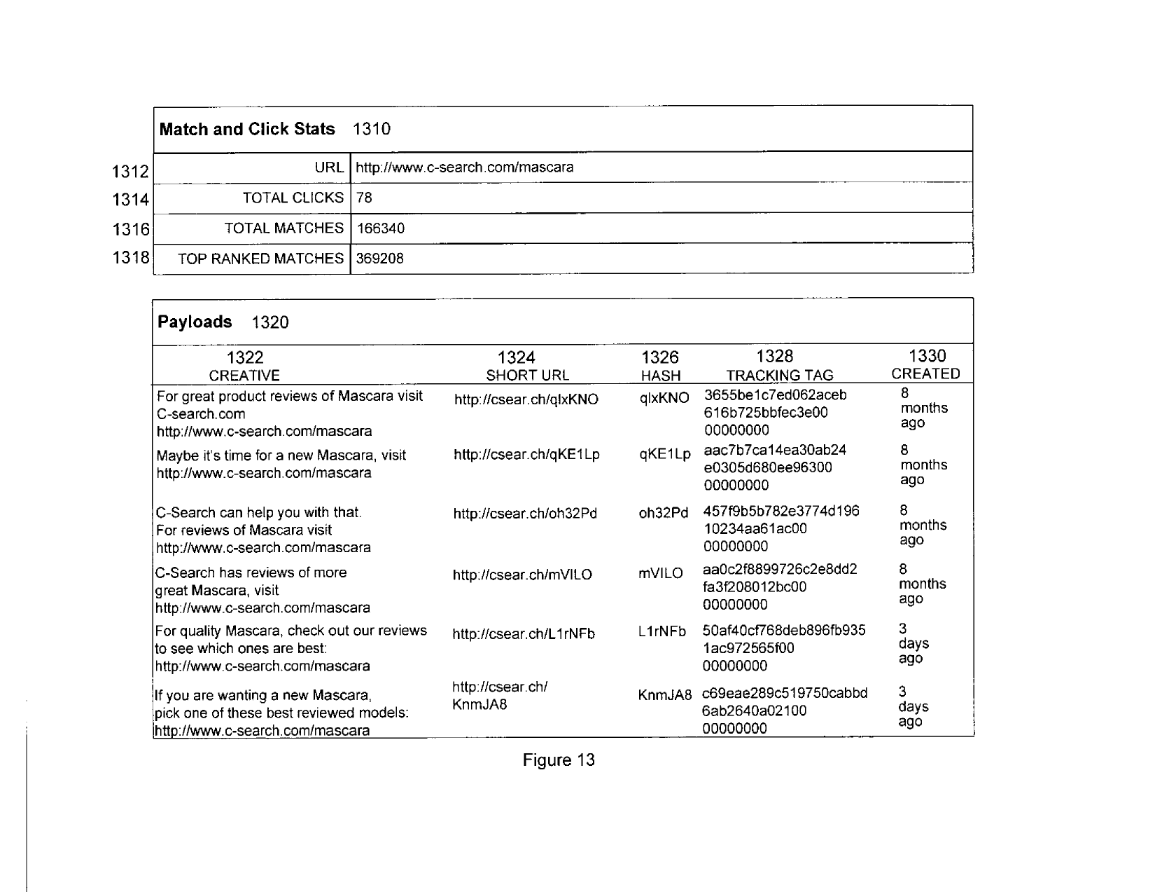

FIG. 13 is an exemplary screen shot illustrating response URL details, according to an embodiment of the present invention. Clicking View 1220 in FIG. 12 may display details on that URL, including in which creatives that payload was used, its shortened URL, its tracking tag, and when it was used. In this example, Match and Click Stats 1310 may be shown, including URL 1312, total clicks 1314, total matches 1316 and top ranked matches 1318. In the Payloads graphic at 1320, creatives may be identified at 1322, a shortened URL at 1324, hash 1326, tracking tag at 1328 and when the creative was created at 1330. Other variations of the details shown in FIG. 13 may be displayed.

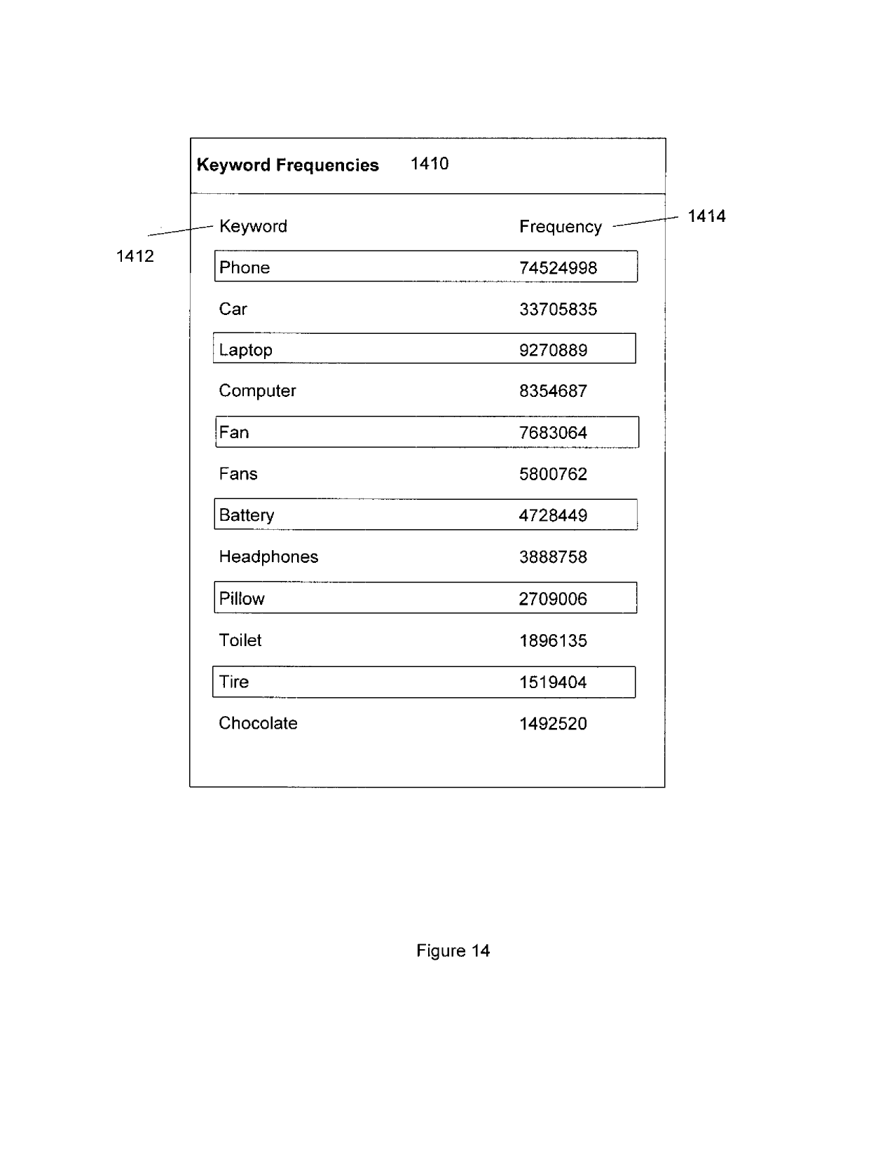

FIG. 14 is an exemplary screen shot illustrating keyword frequencies, according to an embodiment of the present invention. The Keyword Frequencies table 1410 displays the total number of user generated items that match a tracked keyword. In this example, the keywords may be shown at 1412 and the keyword frequency at 1414. As shown in FIG. 14, the word “pillow” was seen in 2,709,006 incoming user generated items. Other variations of the details shown in FIG. 14 may be displayed.

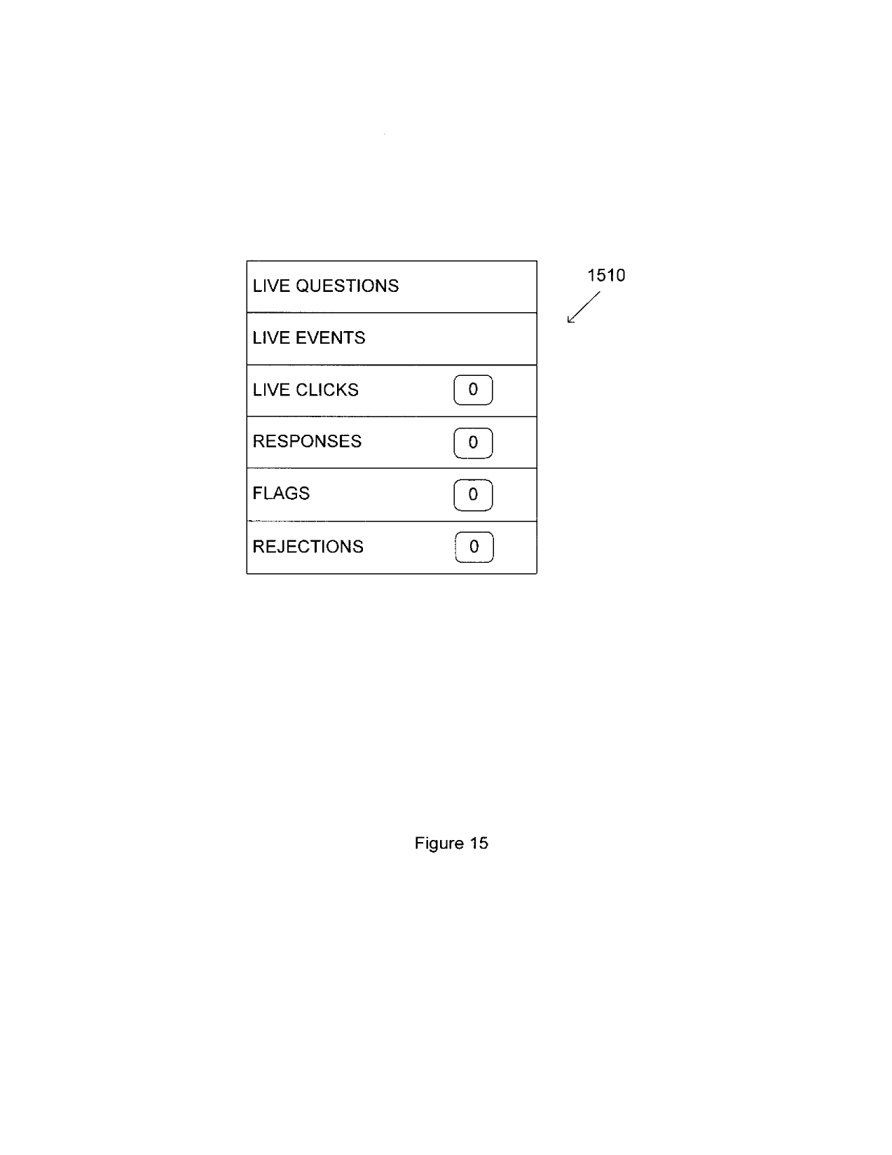

FIG. 15 is an exemplary screen shot illustrating a real-time activities panel, according to an embodiment of the present invention. The interactive panel 1510 displays real time statistics while logged in to the administrative interface. Users may click on an item to expand the view and display the selected statistics in real time. Other variations of the details shown in FIG. 15 may be displayed.

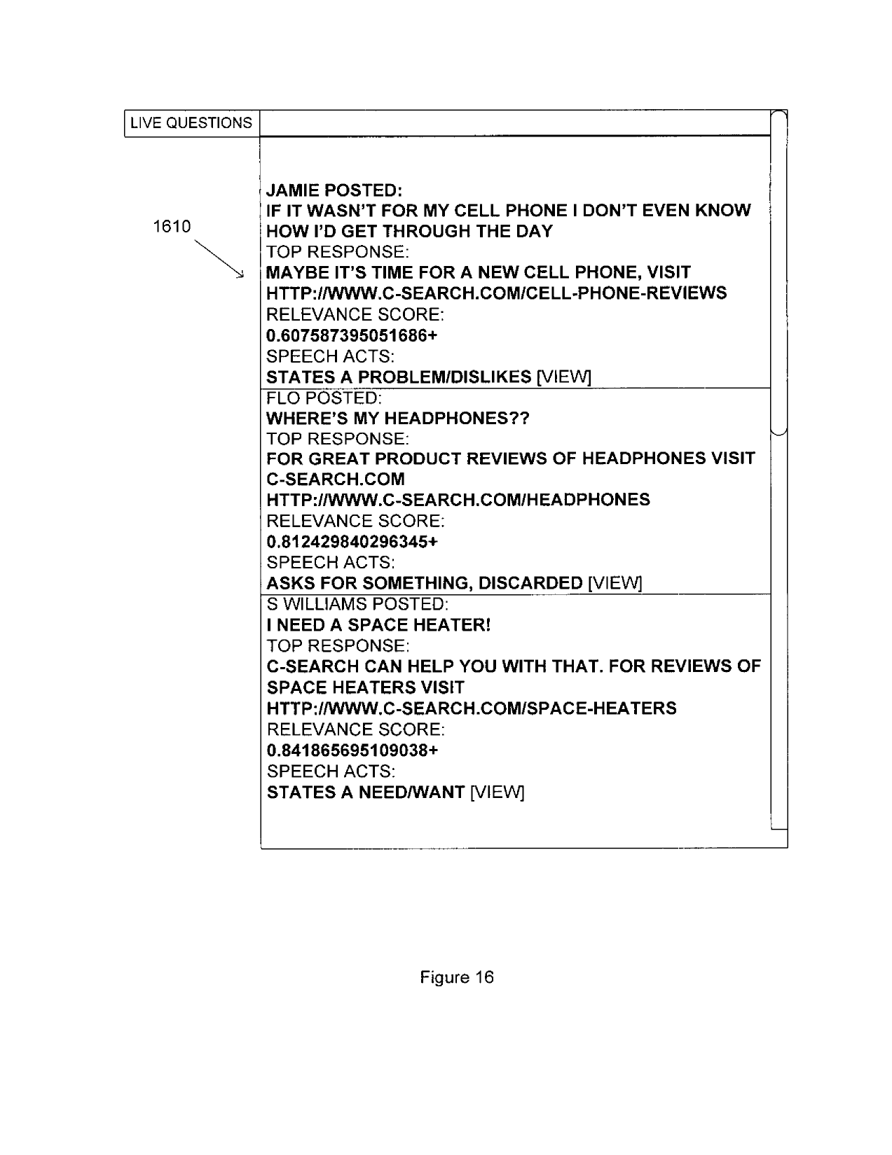

FIG. 16 is an exemplary screen shot illustrating a live questions graphic, according to an embodiment of the present invention. For example, if a user clicks on the Live Questions button in FIG. 15, a graphic shown by 1610 may be displayed. This displays all user generated content events that the system has determined to be worthy of a response as they arrive. This is helpful for users that wish to respond manually to items as they arrive into the system. Other variations of the details shown in FIG. 16 may be displayed.

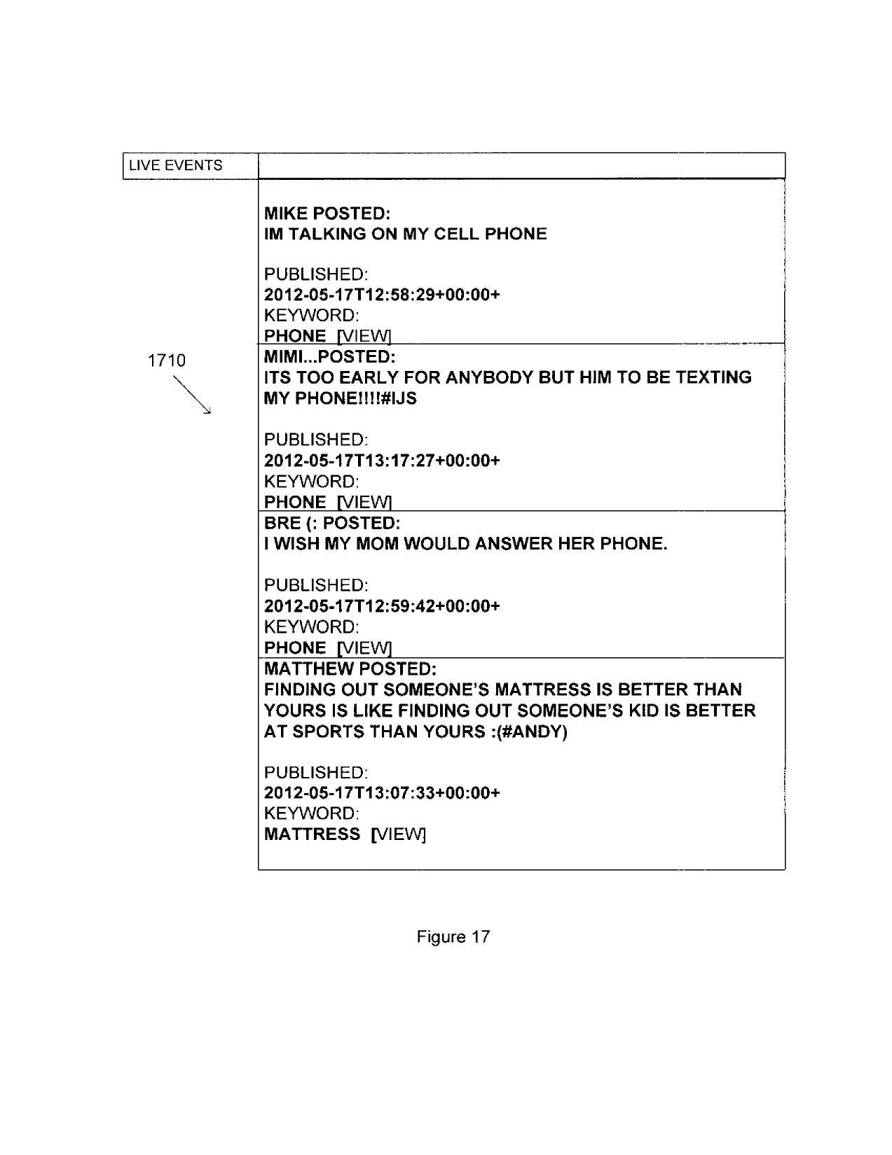

FIG. 17 is an exemplary screen shot illustrating a live events graphic, according to an embodiment of the present invention. This displays all user generated content events as they arrive in real time, as shown by 1710. These events have just been received and have not had any processing performed on them besides storing it in the data store. Other variations of the details shown in FIG. 17 may be displayed.

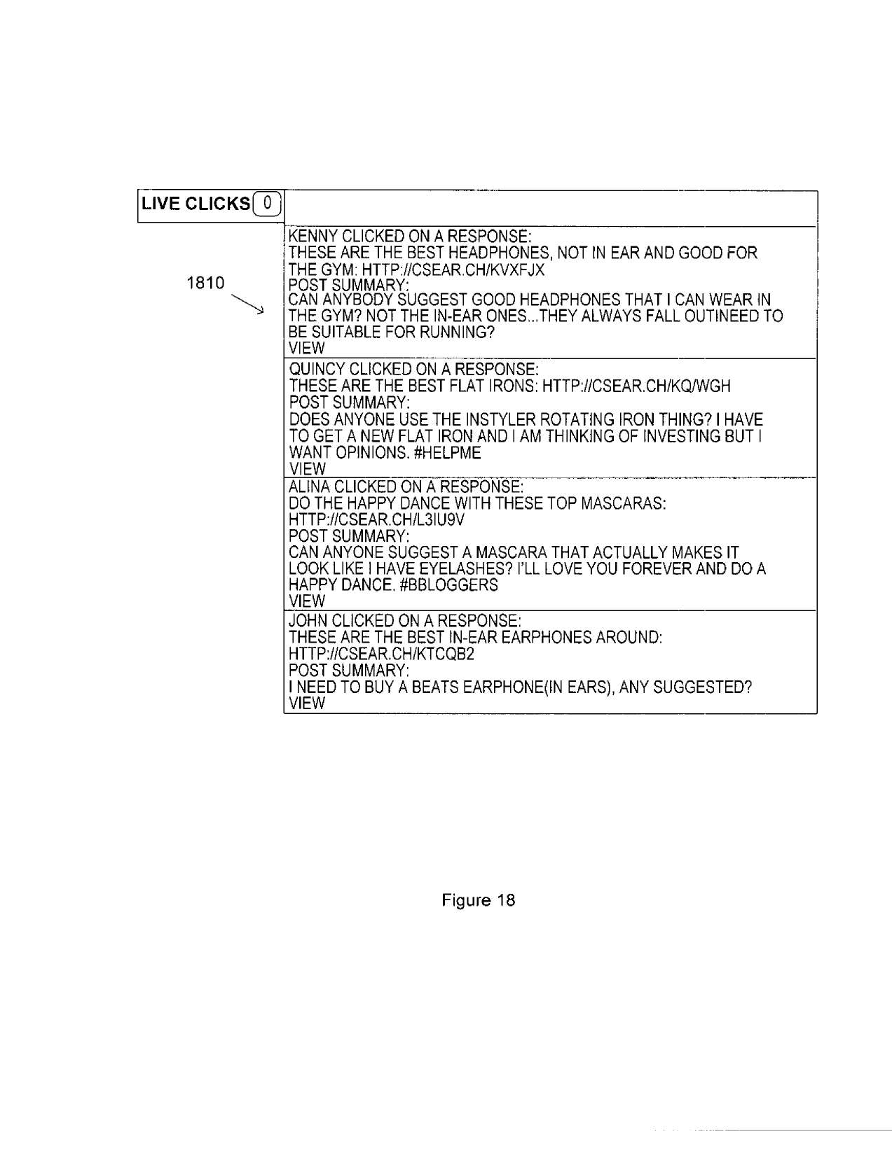

FIG. 18 an exemplary screen shot illustrating a live clicks graphic, according to an embodiment of the present invention. As URLs that were included in replies are clicked by social media users, the clicks are recorded by the system and can be viewed in real time in this view, shown as 1810. Other variations of the details shown in FIG. 18 may be displayed.

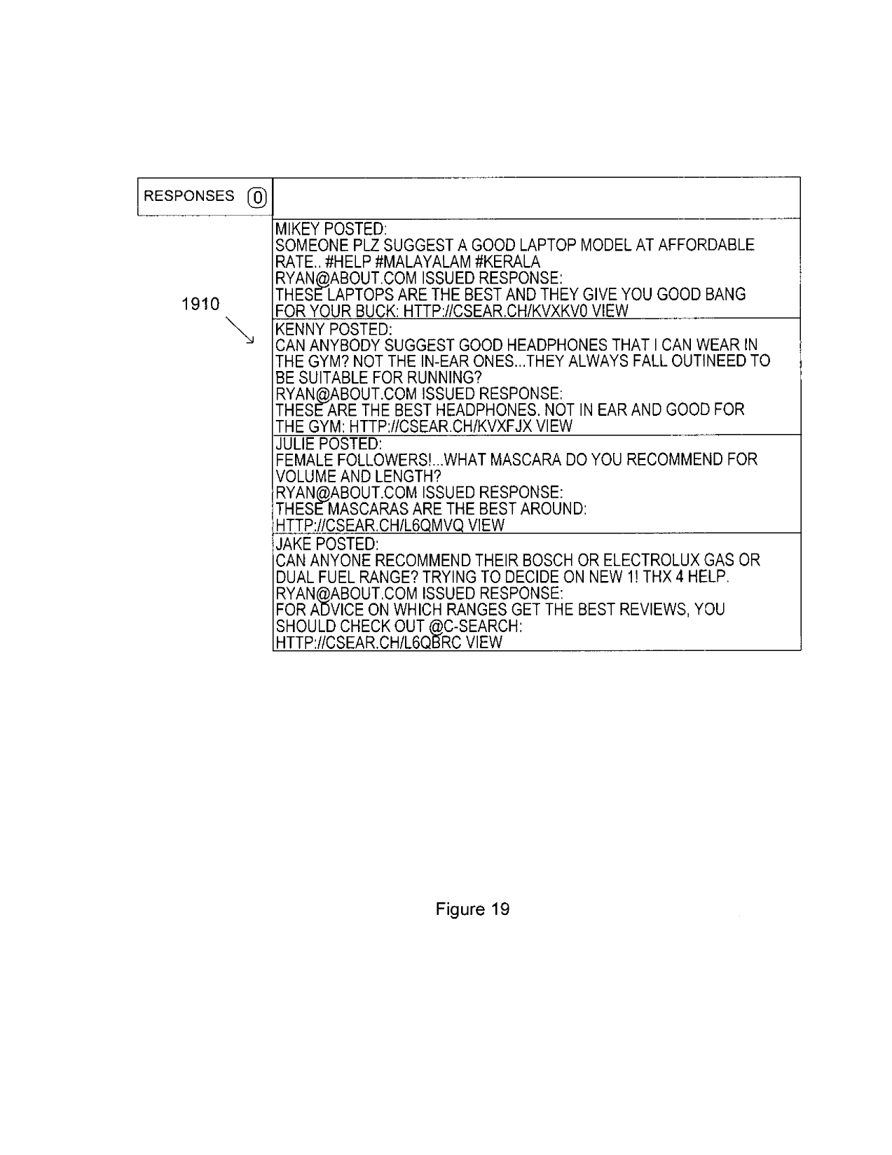

FIG. 19 an exemplary screen shot illustrating a responses graphic, according to an embodiment of the present invention. As the system sends out automatic replies, and as Editor users manually reply to events, these responses are displayed in real time in this view, shown as 1910. Other variations of the details shown in FIG. 19 may be displayed.

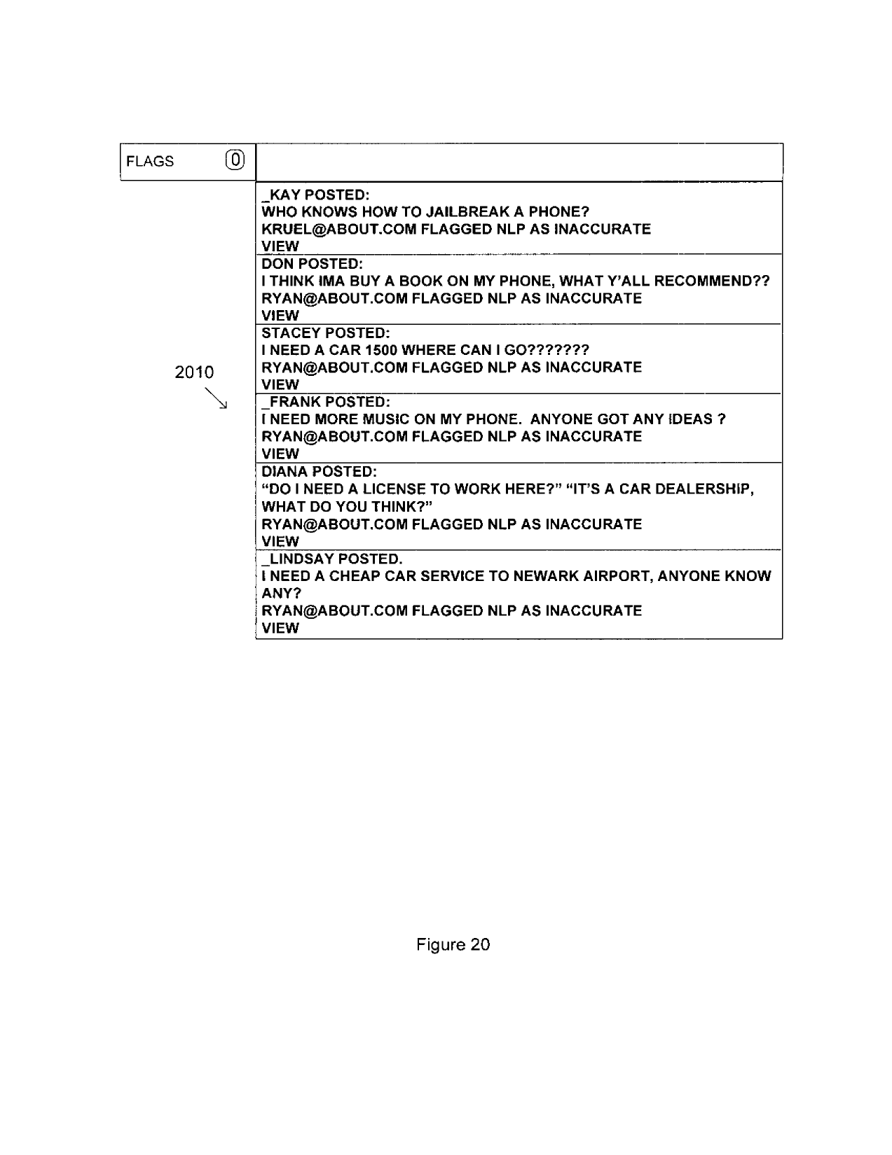

FIG. 20 an exemplary screen shot illustrating a flags graphic, according to an embodiment of the present invention. Events that the system Editor users have specified as not accurately classified by the natural language processing API are displayed in this view, shown as 2010 in real time. Other variations of the details shown in FIG. 20 may be displayed.

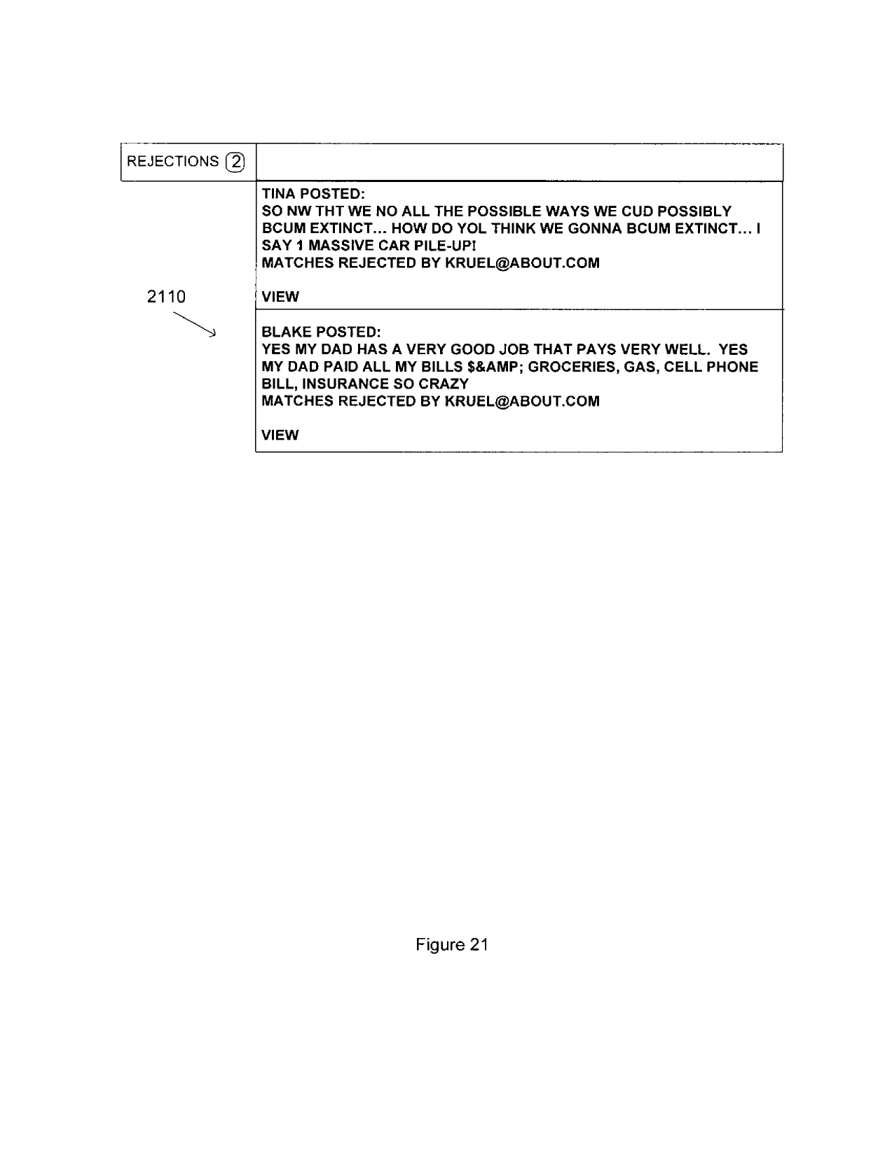

FIG. 21 an exemplary screen shot illustrating a rejections graphic, according to an embodiment of the present invention. An embodiment of the present invention may automatically determine the reply text and publisher content URL that best answers the event text. If a system Editor user determines that a response is not a good match for the event, the user can reject the response. Those rejections are displayed in this view, shown as 2110. Other variations of the details shown in FIG. 21 may be displayed.

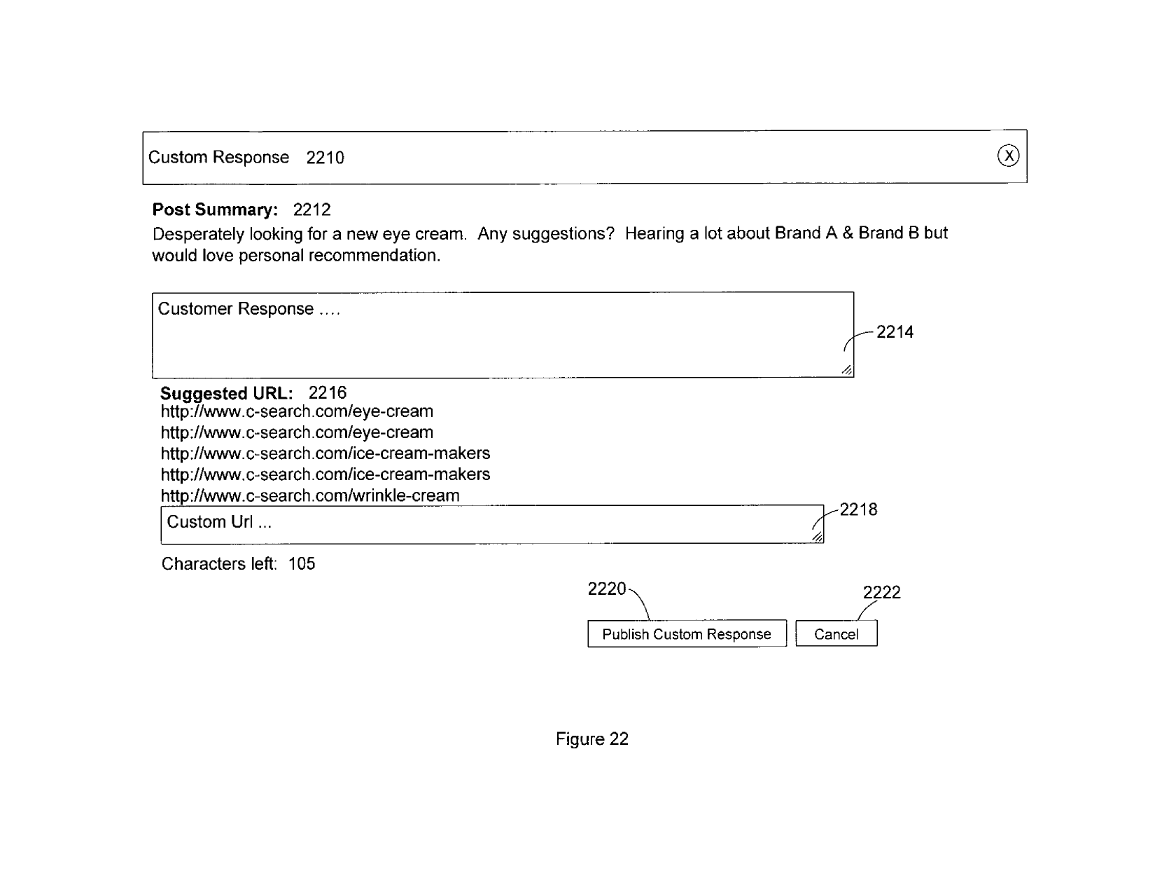

FIG. 22 is an exemplary screen shot illustrating a custom response graphic, according to an embodiment of the present invention. When an administrative user chooses to send a custom response, a Custom Response view 2210 may be displayed. For example, Custom Response view 2202 may appear over a main interface which allows the user to compose a custom response. A post summary may be shown at 2212, which displays or summarizes user generated content, which may include a status update on a social networking site. The user may create a response text in the “Custom Response” field 2214, and may also enter publisher content URL, as displayed at 2216, of their choosing into “Custom URL” field 2218. As the response is created, a counter may keep track of the number of characters in the response. This is useful for platforms that limit posts to a number of characters. Other limitations may be applied. Clicking “Publish Custom Response” at 2220 may then send the response to the social media user. The user may also select cancel at 2222. Other variations of the details shown in FIG. 22 may be displayed.

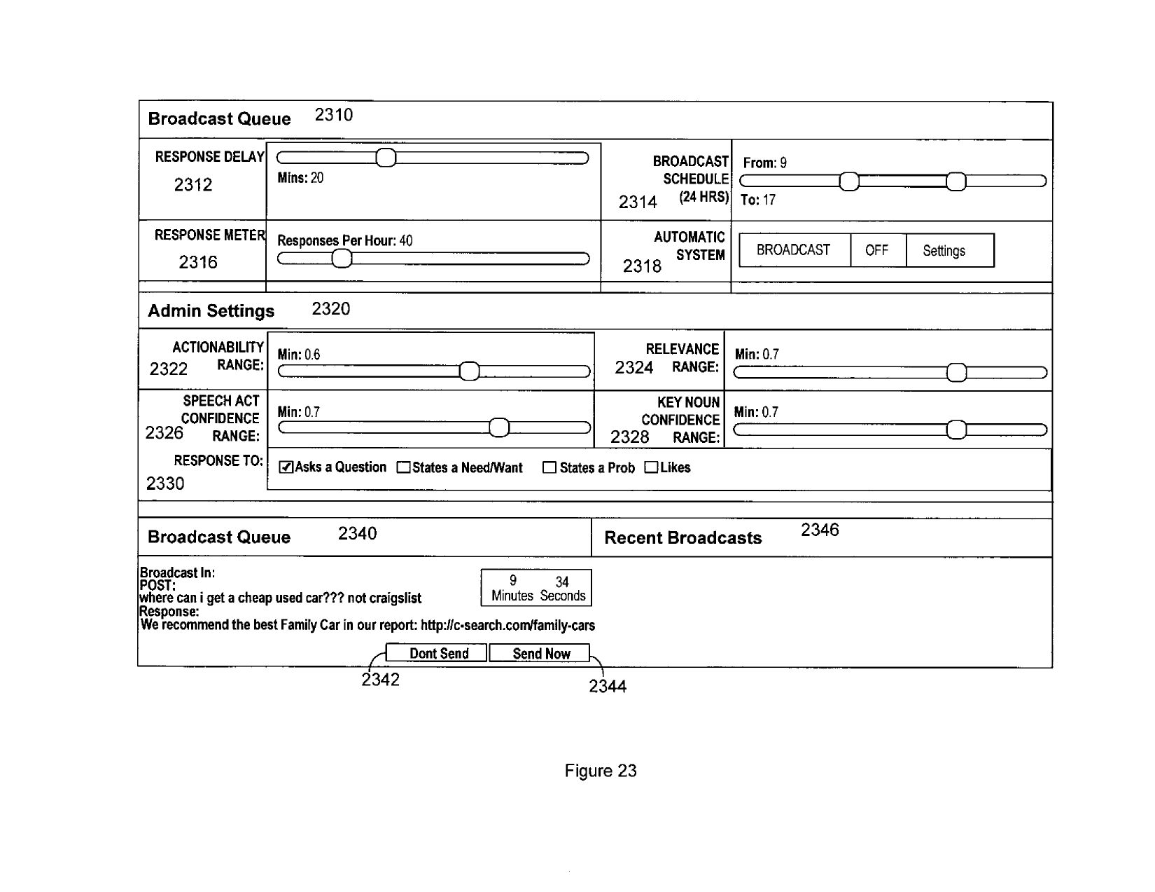

FIG. 23 an exemplary screen shot illustrating an automatic response interface, according to an embodiment of the present invention. For example, editors may reply to items manually or choose to automatically send out a predetermined response. The system of an embodiment of the present invention may also send out replies automatically if a predetermined criteria is met. The automatic responding may be configured in various ways.

An embodiment of the present invention may be used in a manual or automated mode and may send responses to multiple users. The system of an embodiment of the present invention may feature functionality that allows for various delays between event post, reply, and frequency of response to the same individual to determine the timeframe and frequency of responses most desirable for people posting questions. FIG. 23 displays actionable, incoming items and their responses prior to being automatically delivered. For example, a Manager user may make adjustments to the outbound queue. In particular, Response Delay 2312 may represent the amount of time 2312, in minutes or other, that the system of an embodiment of the present invention will wait between when the item was received and when the response will be automatically delivered. This allows Editors to quality control the system and better train the system. Broadcast Schedule 2314 may set the time of day during which automatic responding may be enabled. This allows Editors to monitor automatic responding while they are actively logged in to the system and further prevents the system from sending replies automatically if no one is around. Again, this setting is for quality control. Response Meter 2316 may limit the number of responses per hour. This is useful if the user would like to throttle automatic responses. Automatic System 2318 allows Manager users to globally enable or disable automatic responding and to access additional settings.

Administrative Settings, shown at 2320, allow Manager users to refine the system's selection of which incoming items to include in automatic responding. These settings are similar to the Questions view mentioned above (see FIG. 15). Through these settings the Manager user may set the scores for actionability at 2322, relevance at 2324, speech act confidence at 2326, and key noun phrase confidence at 2328 by which each incoming user generated content is measured. Manager users may also select which items that have certain speech act classifications will be responded to, as shown by 2330. For example, a Manager might want the system to automatically respond to social media users stating a need or a want and no other incoming items. As responses are automatically delivered they may be moved from the “Broadcast Queue” column 2340 to the “Recent Broadcasts” column 2346. Also, items may appear in the “Broadcast Queue” column 2340 as they are received and may be removed once the “Response Delay” time, as indicated at 2312, has elapsed. Editor users may perform manual actions on items in the “Broadcast Queue” column 2340. These actions may be the same or similar as in the Questions view (shown in FIG. 15) and may include “Respond,” Approve NLP,” “Reject NLP,” “Reject Response,” and “Custom.” A user may send the response by selecting 2344 or not send the response by selecting 2342. Other variations of the details shown in FIG. 23 may be displayed.

When a social media user clicks on a reply sent by an embodiment of the present invention, they may be taken to the URL on the publisher's website. A library, for example, may be installed on the publisher's web site that shows an overlay to the social media visitor when they arrive on the URL.

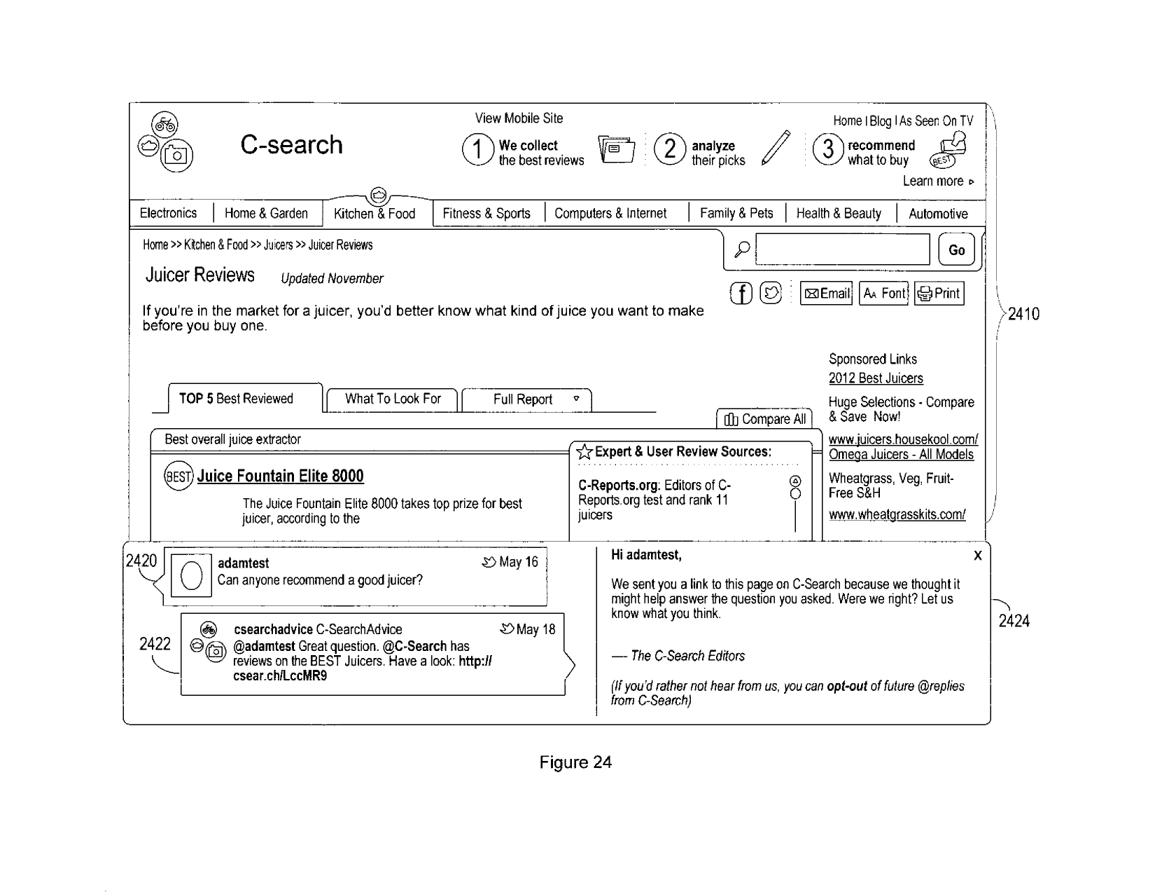

FIG. 24 an exemplary screen shot illustrating an overlay at a publisher's website, according to an embodiment of the present invention. The publisher's website is shown at 2410. This exemplary overlay shows the original social media post the visitor made on the social media platform at 2420 and a response that went out through the publisher's social media account at 2422. On the right, a message may be displayed to the user, at 2424, along with options, such as a feedback opportunity and an opt-out opportunity. Feedback from data may be sent to the system and recorded in a database for that event. If the user chooses to opt-out, the system will not send a reply to that user from the publisher's account. Other publishers, however, may continue to send replies to that user unless they opt-out of those publishers' replies. Other variations of the details shown in FIG. 24 may be displayed.

The description above describes systems, networks, and reader devices, that may include one or more modules, some of which are explicitly shown in the figures. As used herein, the term “module” may be understood to refer to any, or a combination, of computer executable software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein is tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

1. A computer implemented method for automatically generating a response to a user generated content, the method comprising:
receiving, via at least one interface via a communication network, user generated content from at least one social networking source;
processing, via at least one natural language processor, one or more terms from the user generated content to identify the user generated content;
matching, via at least one computer processor, the identified user generated content with at least one resource provided by a content provider;
extracting, from an electronic storage component, a reference to the at least one resource;
generating, via at least one computer processor, a response to the user generated content, wherein the resource comprises the reference to the at least one resource; and
providing, via a communication network, the response to the social networking source.

2. The method of claim 1, further comprising the step of:
filtering the user generated content to exclude ineligible content.

3. The method of claim 1, further comprising the step of:
classifying the user generated content to one or more categories comprising (1) stating a need or want, (2) stating a problem, (3) asking a question, (4) likes, and (5) dislikes.

4. The method of claim 1, further comprising the step of:
assigning a speech act confidence score to the user generated content wherein the speech act confidence score represents a level of certainty that the user generated content is classified correctly.

5. The method of claim 1, further comprising the step of:
assigning a key noun score to the user generated content wherein the key noun score represents a level of similarity with one or more tagged keywords used to identify the user generated content.

6. The method of claim 1, further comprising the step of:
assigning a relevancy score to the user generated content wherein the relevancy score represents a level of relevancy between the user generated content and the matched resource.

7. The method of claim 1, further comprising the step of:
assigning an actionability score to the user generated content wherein the actionability score represents an indication of applicability of the resource associated with a content provider to the user generated content.

8. The method of claim 1, further comprising the step of:
adding a tag to the response to track user interaction with the response.

9. The method of claim 1, further comprising the step of:
identifying one or more keywords to identify user generated content.

10. The method of claim 1, further comprising the step of:
customizing the response for an author of the user generated content.

11. A computer implemented system for automatically generating a response to a user generated content, the system comprising:
an interface configured to receive, via a communication network, user generated content from at least one social networking source;
a natural language processor configured to process one or more terms from the user generated content to identify the user generated content;
a programmed computer processor configured to match the identified user generated content with at least one resource provided by a content provider;
an electronic storage component configured to store a reference to the at least one resource;
a programmed computer processor configured to generate a response to the user generated content, wherein the resource comprises the reference to the at least one resource; and
a programmed computer processor configured to provide, via a communication network, the response to the social networking source.

12. The system of claim 11, further comprising a programmed computer processor configured to filter the user generated content to exclude ineligible content.

13. The system of claim 11, further comprising a programmed computer processor configured to classify the user generated content to one or more categories comprising (1) stating a need or want, (2) stating a problem, (3) asking a question, (4) likes, and (5) dislikes.

14. The system of claim 11, further comprising a programmed computer processor configured to assign a speech act confidence score to the user generated content wherein the speech act confidence score represents a level of certainty that the user generated content is classified correctly.

15. The system of claim 11, further comprising a programmed computer processor configured to assign a key noun score to the user generated content wherein the key noun score represents a level of similarity with one or more tagged keywords used to identify the user generated content.

16. The system of claim 11, further comprising a programmed computer processor configured to assign a relevancy score to the user generated content wherein the relevancy score represents a level of relevancy between the user generated content and the matched resource.

17. The system of claim 11, further comprising a programmed computer processor configured to assign an actionability score to the user generated content wherein the actionability score represents an indication of applicability of the resource associated with a content provider to the user generated content.

18. The system of claim 11, further comprising a programmed computer processor configured to add a tag to the response to track user interaction with the response.

19. The system of claim 11, further comprising a programmed computer processor configured to identify one or more keywords to identify user generated content.

20. The system of claim 11, further comprising a programmed computer processor configured to customize the response.
